(19) United States
(12) Patent Application Publication
(10) Pub. No.: US 2010/0233506 A1
(43) Pub. Date: Sep. 16, 2010

(54) SILVER-COATED COMPOSITE MATERIAL FOR MOVABLE CONTACT AND METHOD FOR MANUFACTURING THE SAME

(75) Inventors: Naofumi Tokuhara, Tokyo (JP); Masato Ohno, Tokyo (JP); Takeo Uno, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: FURUKAWA ELECTRIC CO., LTD., TOKYO (JP)

(21) Appl. No.: 12/680,350

(22) PCT Filed: Sep. 25, 2008
(86) PCT No.: PCT/JP2008/067275

§ 371 Date: Mar. 26, 2010

(30) Foreign Application Priority Data
Sep. 26, 2007 (JP) 2007-250204
Sep. 26, 2007 (JP) 2007-250205
Sep. 26, 2007 (JP) 2007-250206
Sep. 19, 2008 (JP) 2008-240326
Sep. 19, 2008 (JP) 2008-240327
Sep. 19, 2008 (JP) 2008-240328

(51) Int. Cl. B32B 15/01; C25D 5/10; C25D 5/34

(52) U.S. Cl. 428/637; 428/671; 428/673; 205/176

(57) ABSTRACT

A silver-coated composite material for movable contact includes a base material composed of an alloy whose main component is iron or nickel, an under layer which is formed at least on part of the surface of the base material and which is composed of any one of nickel, cobalt, nickel alloy and cobalt alloy, an intermediate layer which is formed on the under layer and which is composed of copper or copper alloy and an outermost layer which is formed on the intermediate layer and which is composed of silver or silver alloy, and wherein a total thickness of the under layer and the intermediate layer falls within a range more than 0.025 μm and less than 0.20 μm.

### TECHNOLOGICAL FIELD

The present invention relates to a silver-coated composite material for use as a movable contact and a method for manufacturing the same and more specifically to a silver-coated composite material by which a long-life movable contact may be obtained and to a method for manufacturing the same.

### BACKGROUND ART

A disc spring contact, a brush contact, a clip contact and the like are used as an electrical contact in a connector, a switch, a terminal and the like. For such contacts, a silver-coated composite material in which nickel is primarily plated on a base material such as copper alloy and iron and nickel alloy including stainless steel that are relatively inexpensive and excel in corrosion-resistance and mechanical properties and silver that excels in electrical conductivity and solderability is cladded thereon is often used (see Patent Document 1).

The silver-coated composite material using stainless steel as the base material excels in terms of mechanical properties and fatigue life as compared to one using the copper alloy as the base material in particular, so that it is advantageous for downsizing the contact. It also allows a number of operation times to be increased, so that it is used as a movable contact of a tactile push switch, a detection switch and the like.

However, the silver-coated composite material in which nickel is primarily plated on the base material of stainless steel and silver is cladded thereon has had a problem that because a contact pressure of the switch is large, a silver-coated layer at a contact point is prone to be peeled off during repetitive contact switching operations. This phenomenon is comprehended to occur due to the following reason.

In a silver-coated composite material 900 illustrated in FIG. 11, an under layer 902 and an outermost layer 903 are formed on a base material 901 composed of stainless steel (in FIG. 11(a)). Nickel forming the under layer 902 and silver forming the outermost layer 903 have such a property that they are not solid-soluble from each other and such a phenomenon that oxygen infiltrates and diffuses through the outermost layer 903 occurs. Due to that, the oxygen infiltrated and diffused through the outermost layer 903 reaches the interface between the under layer 902 and the outermost layer 903, generates an oxide 914 with nickel here and hence drops adhesion between the under layer 902 and the outermost layer 903 (FIG. 11(b)).

As a means for solving the problem described above, there has been proposed a silver-coated composite material (see Patent Documents 2 through 5) in which an under layer (nickel layer), an intermediate layer (copper layer) and an outermost layer (silver layer) are electrically plated on the base material of stainless steel in this order. FIG. 12 shows one example of the silver-coated composite material formed by using such technologies. In the silver-coated composite material 910, a layer formed of copper that is solid-soluble to both nickel and silver from each other is provided as an intermediate layer 913 between an under layer 912 and an outermost layer 914 (FIG. 12). Thus, it becomes possible to enhance adhesion of the respective layers by mutually diffusing among the intermediate layer 913 and the respective layers 912 and 914. Still more, this arrangement has an effect of preventing the drop of the adhesion otherwise caused by oxygen stored in the interface by capturing the oxygen infiltrated from the atmosphere and diffused within the outermost layer 914 by the solid-soluble copper coming from the intermediate layer 113 to the outermost layer 114. Thus, this arrangement permits to prevent the adhesion from dropping.
Patent Document 1: Japanese Patent Application Laid-open No. Sho. 59-219945
Patent Document 2: Japanese Patent Application Laid-open No. 2004-263274
Patent Document 3: Japanese Patent Application Laid-open No. 2005-2400
Patent Document 4: Japanese Patent Application Laid-open No. 2005-133169
Patent Document 5: Japanese Patent Application Laid-open No. 2005-174788

### DISCLOSURE OF THE INVENTION

### Problem to Be Solved by the Invention

However, it has been found that the technologies described above have the following drawbacks. That is, there is a problem that as compared to the case of the prior art silver-coated composite material formed by electrically plating the nickel layer and the silver layer in this order, an increase of contact resistance when the contact is used for a long period of time is faster when the intermediate layer composed of copper is formed. Still more, if at least either one of the under layer (nickel layer) and the intermediate layer (copper layer) is too thick, flexibility of those layers drops. As a result, it has been found that it may cause such a trouble that at least one of the under layer and the intermediate layer generates cracks during press working or the like.

Accordingly, the invention aims at providing a silver-coated composite material for movable contact, and a manufacturing method thereof, having high workability for press-working and the like, whose silver-coated layer will not peel off even if it is used as a movable contact and switching operation is repeatedly carried out and whose increase of contact resistance is suppressed even if it is used for a long period of time, thus allowing the long-life movable contact.

The invention also aims at providing a silver-coated composite material for movable contact, and a manufacturing method thereof, having the high workability for press-working and the like, whose silver-coated layer will not peel off even if it is used as a movable contact and switching operation is repeatedly carried out, whose increase of contact resistance is suppressed even if it is used for a long period of time, thus allowing the long-life movable contact, and whose inter-layer adhesion is remarkably improved.

### Means for Solving the Problem

In view of the circumstances described above, the inventor et al. have ardently studied this subject and found that the increase of contact resistance occurs because copper solid-dissolved from the intermediate layer to the outermost layer reaches the surface of the outermost layer, is oxidized and generates highly resistant oxide (FIG. 13). It was also found that as a solution of such problem, it is possible to prevent the increase of the contact resistance by reducing an amount of copper that reaches the surface of the outermost layer by reducing the thickness of the intermediate layer. It was also found that it is possible to suppress the crack during pressing and to suppress the increase of the contact resistance during repetitive switching operations of the contact by thinning the under layer and the intermediate layer. It was also found that the adhesion at the interface between the under layer and the intermediate layer may be remarkably improved by forming wavy irregularity at the interface between the under layer and the intermediate layer. It was also found that the adhesion at the interface between the under layer and the intermediate layer may be remarkably improved by forming portions where the under layer (underlying region) is missed so that the intermediate layer contacts directly with the base material and contacting the intermediate layer directly with the base material through the underlying region. The present invention was made based on the findings described above.

According to a first aspect of invention, a silver-coated composite material for movable contact includes a base material composed of an alloy whose main component is iron or nickel, an under layer which is formed at least on part of the surface of the base material and which is composed of any one of nickel, cobalt, nickel alloy and cobalt alloy, an intermediate layer which is formed on the under layer and which is composed of copper or copper alloy and an outermost layer which is formed on the intermediate layer and which is composed of silver or silver alloy, and is characterized in that a total thickness of the under layer and the intermediate layer falls within a range more than 0.025 μm and less than 0.20 μm.

A second aspect of the silver-coated composite material for movable contact of the invention is characterized in that the thickness of the under layer is 0.04 μm or less.

A third aspect of the silver-coated composite material for movable contact of the invention is characterized in that the thickness of the under layer is 0.009 μm or less.

A fourth aspect of the silver-coated composite material for movable contact of the invention is characterized in that the base material is stainless steel.

A fifth aspect of the silver-coated composite material for movable contact of the invention is characterized in that irregularity is formed at the interface between the under layer and the intermediate layer.

A sixth aspect of the silver-coated composite material for movable contact of the invention is characterized in that irregularity is formed at the interface between the intermediate layer and the outermost layer.

A seventh aspect of the silver-coated composite material for movable contact of the invention is characterized in that missing portions are formed at a plurality of spots of the under layer so that the intermediate layer contacts directly with the surface of the base material.

A first aspect of a method for manufacturing a silver-coated composite material for movable contact includes a first step of electrolytic-degreasing a base material of a metal strip composed of an alloy whose main component is iron or nickel and of pickling and activating the base material by hydrochloric acid, a second step of forming an under layer by implementing either nickel plating by electrolyzing with an electrolytic solution containing nickel chloride and free hydrochloric acid or plating nickel alloy plating by electrolyzing by adding cobalt chloride to the electrolytic solution containing nickel chloride and free hydrochloric acid, a third step of forming an intermediate layer by implementing either copper plating by electrolyzing with an electrolytic solution containing copper sulfate and free sulfuric acid or copper alloy plating by electrolyzing by adding zinc cyanide or potassium stannate based on copper cyanide and potassium cyanide and a fourth step of foaming an outermost layer by implementing either silver plating by electrolyzing with an electrolytic solution containing silver cyanide and potassium cyanide or silver alloy plating by electrolyzing by adding antimonyl potassium tartrate to the electrolytic solution containing silver cyanide and potassium cyanide, and characterized in that the silver-coated composite material for movable contact is manufactured so that a total thickness of the under layer and the intermediate layer thereof falls within a range more than 0.025 μm and less than 0.20 μm.

A second aspect of the method for manufacturing the silver-coated composite material for movable contact of the invention is characterized in that a silver-coated composite material is formed by implementing silver strike plating by electrolyzing with an electrolytic solution containing silver cyanide and potassium cyanide after implementing either the copper plating or the copper alloy plating and before implementing either the silver plating or the silver alloy plating.

A third aspect of the method for manufacturing the silver-coated composite material for movable contact of the invention is a method for manufacturing the silver-coated composite material for movable contact having a base material composed of an alloy whose main component is iron or nickel, an under layer which is formed at least on part of the surface of the base material and which is composed of any one of nickel, cobalt, nickel alloy and cobalt alloy, an intermediate layer which is formed on the under layer and which is composed of copper or copper alloy and an outermost layer which is formed on the intermediate layer and which is composed of silver or silver alloy, wherein a total thickness of the under layer and the intermediate layer falls within a range more than 0.025 μm and less than 0.20 μm, and characterized in that the under layer is formed by pickling and activating the base material by an acid solution at least containing nickel ion or cobalt ion after electrolytic-degreasing the base material.

A fourth aspect of the method for manufacturing the silver-coated composite material for movable contact of the invention includes a first step of electrolytic-degreasing a base material of a metal strip composed of an alloy whose main component is iron or nickel and then forming an under layer composed any one of nickel, cobalt, nickel alloy and cobalt alloy on the base material through an activation process of pickling and activating the base material by an acid solution containing at least nickel ion or cobalt ion, a second step of forming an intermediate layer by plating either copper by electrolyzing with an electrolytic solution containing copper sulfate and free sulfuric acid or copper alloy by adding zinc cyanide or potassium stannate to the electrolytic solution containing copper cyanide and potassium cyanide and a third step of forming an outermost layer on the intermediate layer by implementing silver plating with an electrolytic solution containing silver cyanide and potassium cyanide or silver alloy plating by electrolyzing by adding antimonyl potassium tartrate to the electrolytic solution containing silver cyanide and potassium cyanide, and characterized in that the silver-coated composite material for movable contact is manufactured so that a total thickness of the under layer and the intermediate layer thereof falls within a range more than 0.025 μm and less than 0.20 μm.

A fifth aspect of the method for manufacturing the silver-coated composite material for movable contact of the invention is characterized in that cathode current density during the activation process is set within a range from 2.0 to 5.0 (A/dm²).

A sixth aspect of the method for manufacturing the silver-coated composite material for movable contact of the invention is characterized in that the cathode current density during the activation process is set within a range from 3.0 to 5.0 (A/dm²) and the silver-coated composite material for movable contact is manufactured so that the thickness of the under layer is 0.04 μm or less.

A seventh aspect of the method for manufacturing the silver-coated composite material for movable contact of the invention is characterized in that the cathode current density during the activation process is set within a range from 2.5 to 4.0 (A/dm²) and the silver-coated composite material for movable contact is manufactured so that irregularity is formed at the interface between the under layer and the intermediate layer.

An eighth aspect of the method for manufacturing the silver-coated composite material for movable contact of the invention is characterized in that the cathode current density during the activation process is set within a range from 2.0 to 3.5 (A/dm²) and the silver-coated composite material for movable contact is manufactured so that missing portions are formed at a plurality of spots of the under layer so that the intermediate layer contacts directly with the surface of the base material.

A ninth aspect of the method for manufacturing the silver-coated composite material for movable contact of the invention is characterized in that the base material is a metal strip.

A tenth aspect of the method for manufacturing the silver-coated composite material for movable contact of the invention is characterized in that the base material is composed of stainless steel.

### ADVANTAGES OF THE INVENTION

As described above, the invention can provide the silver-coated composite material for movable contact, and its manufacturing method, whose silver-coated layer is not peeled off even if it is used as a movable contact and switching operations thereof are repeatedly carried out and which is capable of suppressing the increase of the contact resistance even used for a long period of time.

According to the invention, a copper amount within the outermost layer may be suppressed under a predetermined value and the increase of the contact resistance may be suppressed by forming the under layer to a predetermined thickness.

The invention can also provide the silver-coated composite material for movable contact, and its manufacturing method, whose silver-coated layer is not peeled off even if it is used as the movable contact and switching operations thereof are repeatedly carried out, which is capable of suppressing the increase of the contact resistance even used for a long period of time and whose interlayer adhesion is remarkably improved.

According to the invention, the irregularity is formed at the interface between the under layer and the intermediate layer, so that a contact area of the both layers increases and the adhesion of the both is improved due to mutual diffusion between the under layer and the intermediate layer. Adhesion of the both of the intermediate layer and the outermost layer may be also improved due to mutual diffusion between the both layers when irregularity is faulted at the interface between the intermediate layer and the outermost layer.

According to the invention, the missing portions are formed at the plurality of spots of the under layer so that the intermediate layer contacts directly with the surface of the base material, so that the contact area of the underlying region and intermediate layer increases and the adhesion of the both layers is improved by the mutual diffusion of the both layers.

### BRIEF DESCRIPTION OF DRAWINGS

FIG. 1 is a section view showing a silver-coated composite material for movable contact according to a first mode of the invention.

FIG. 2 is a flowchart showing a method for manufacturing the silver-coated composite material for movable contact of the first mode of the invention (manufacturing method of the first mode).

FIG. 3 is a plan view showing a switch formed by using the silver-coated composite material for movable contact of an embodiment shown in Table 1.

FIG. 4A is a section view taken along a line A-A of the switch shown in FIG. 3 and showing an OFF state and FIG. 4B is a section view showing an ON state of the switch.

FIGS. 5A through 5C are diagrammatic views for explaining a method for manufacturing the silver-coated composite material for movable contact of a second mode of the invention (manufacturing method of the second mode).

FIG. 6 is a section view showing a silver-coated composite material for movable contact according to the second mode of the invention.

FIG. 7 is a section view showing a silver-coated composite material for movable contact according to a third mode of the invention.

FIGS. 8A through 8C are diagrammatic views for explaining a method for manufacturing the silver-coated composite material for movable contact of a fourth mode of the invention (manufacturing method of the fourth mode).

FIG. 9 is a section view showing a silver-coated composite material for movable contact according to the fourth mode of the invention.

FIGS. 10A through 5C are diagrammatic views for explaining a method for manufacturing the silver-coated composite material for movable contact of a sixth mode of the invention (manufacturing method of the sixth mode).

FIGS. 11A and 11B are section views showing a prior art silver-coated composite material.

FIG. 12 is a section view showing a different prior art silver-coated composite material.

FIG. 13 is a section view showing an oxide formed in the different prior art silver-coated composite material.

### DESCRIPTION OF REFERENCE NUMERALS

100, 110A, 200, 100B silver-coated composite material for movable contact
110, 210 base material
120, 220 under layer
120a nucleus of nickel (Ni)
130, 230 intermediate layer
140, 240 outermost layer
200 switch
210 domed movable contact
220 fixed contact
230 filler
240 resin case

### BEST MODES FOR CARRYING OUT THE INVENTION

Preferable modes of a silver-coated composite material for movable contact of the invention and its manufacturing method will be explained.

(First Mode of Silver-Coated Composite Material for Movable Contact)

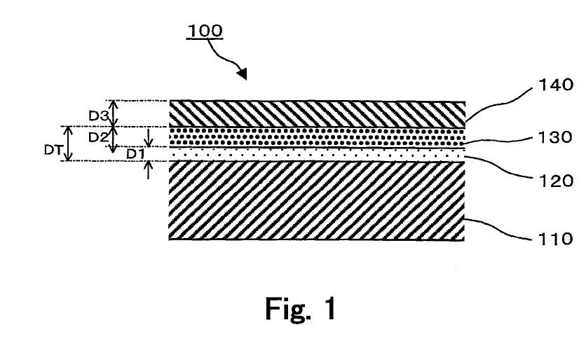

A first mode of the silver-coated composite material for movable contact of the invention will be explained by using a section view shown in FIG. 1. The silver-coated composite material for movable contact 100 of the present mode includes a base material 110 composed of an alloy whose main component is iron or nickel, an under layer 120 formed at least on part of the surface of the base material 110, an intermediate layer 130 formed on the under layer 120 and an outermost layer 140 formed on the intermediate layer 130.

Stainless steel is used for the base material 110 composed of the alloy whose main component is iron or nickel in the present mode. Here, the alloy whose main component is iron or nickel means an alloy whose mass ratio of at least one of iron or nickel is 50 mass % or more. For the stainless steel used for the base material 110 that bears mechanical strength of the movable contact, rolled heat-treated materials or tension-anneal material such as SUS301, SUS304, SUS305, SUS316 and the like that excel in stress relaxing characteristics and fatigue breakdown resistance are suited.

The under layer 120 formed on the base material 110 of stainless steel is formed by any one of nickel, cobalt, nickel alloy and cobalt ally. The under layer 120 is disposed to enhance adhesion of the stainless steel used for the base material 110 and the intermediate layer 130. The intermediate layer 130 is formed by copper or copper alloy and is disposed to enhance adhesion of the under layer 120 with the outermost layer 140. It is noted that another different layer may be provided between the under layer 120 and the base material 110 for a specific purpose.

While nickel, cobalt or alloy whose main component is nickel or cobalt (the whole mass ratio is 50 mass % or more) is used as the metal foiling the under layer 120, it is preferable to use nickel among them. The under layer 120 may be formed by electrolysis by setting the base material 110 composed of stainless steel at the cathode and by using electrolytic solution containing nickel chloride and free hydrochloric acid for example. It is noted that although a case of using nickel as the metal of the under layer 120 will be explained below, the same effect with those explained below will be obtained even if anyone of cobalt, nickel alloy and cobalt alloy is used, beside nickel.

The deterioration of workability of the prior art silver-coated composite material is caused by the drop of flexibility of those layers when at least one of the under layer or the intermediate layer is too thick as described above. Due to that, the silver-coated composite material for movable contact 100 having high workability is formed by thinning the under layer 120 and the intermediate layer 130 within a range in which the interlayer adhesions between the surface of the base material 110 and the under layer 120, between the under layer 120 and the intermediate layer 130 and between the intermediate layer 130 and the outermost layer 140 are maintained in the present mode.

Meanwhile, the increase of the contact resistance is caused by copper in the intermediate layer that is diffused within the silver-coated layer of the outermost layer reaches the outermost layer and is oxidized. That is, the increase of the contact resistance occurs due to the copper solid-dissolved from the intermediate layer 913 to the outermost layer 914 that reaches the surface of the outermost layer 914, is oxidized and generates high electric resistant oxide 915 (see FIG. 13) as FIG. 12 shows its one example.

In order to solve such problem, the preferable thickness of the intermediate layer 130 is determined so that the copper in the intermediate layer 130 does not reach the surface of the outermost layer 140 within the range in which the interlayer adhesions between the surface of the base material 110 and the under layer 120, between the under layer 120 and the intermediate layer 130 and the intermediate layer 130 and the outermost layer 140 in the present mode. The thickness D2 of the intermediate layer 130 is determined so that a total thickness DT in which the thickness D2 of the intermediate layer 130 is added to the thickness D1 of the under layer 120 falls within a range of 0.025 to 0.20 μm in the present mode.

Still more, the thickness D1 of the under layer 120 shown in FIG. 1 is set to be 0.04 μm or less. Such an upper limit is provided for the thickness D1 of the under layer 120 to prevent the deterioration of the workability that is otherwise caused by the too-thick under layer 120. The thickness D1 of the under layer 120 is more preferably to be 0.009 μm or less. In this case, the effect of obtaining the high workability appears more remarkably.

Thereby, it is possible to suppress the diffusion of copper to the surface of the outermost layer 140 and the oxidation caused by that while maintaining the high interlayer adhesion. The most desirable form of the outermost layer is a structure in which it contains copper only in the vicinity of the intermediate layer and it is formed of silver or a silver alloy layer containing no copper near the surface. The thickness D3 of the outermost layer is desirable to be 0.5 to 1.5 μm by taking electrical conductivity, cost and bending workability into consideration.

Although it is preferable to thin the under layer 120 and the intermediate layer 130 from the aspect of improving the workability, the lower limit value of 0.025 μm is set as the total thickness DT of the thicknesses of the under layer 120 and the intermediate layer 130 because the effect of enhancing the interlayer adhesions between the surface of the base material 110 and the under layer 120, between the under layer 120 and the intermediate layer 130 and between the intermediate layer 130 and the outermost layer 140 drops if the thickness falls below this value. Still more, the upper limit value of 0.20 μm is set for the total thickness DT of the thickness of the under layer 120 and the thickness of the intermediate layer 130 because the increase of the contact resistance is prone to occur depending on use environment if the thickness exceeds that value. It is possible to prevent each layer from cracking during pressing by setting the thickness D1 of the under layer 120 and the thickness D2 of the intermediate layer 130 within the range described above.

While each layer of the under layer 120, the intermediate layer 130 and the outermost layer 140 of the silver-coated composite material for movable contact 100 of the present mode may be formed by using an arbitrary method such as electro-plating, nonelectrolytic plating, physical and chemical evaporation and others, the electro-plating is most advantageous from an aspect of productivity and cost among them. Although the respective layers described above may be formed on the whole surface of the base material 110 composed of stainless steel, it is more economical to form by limiting only to the contact point. Still more, a known method such as heat-treatment may be also applied to improve the strength of adhesion between the respective layers.

Further, copper may be alloyed for the layers other than the outermost layer 140 composed of copper or copper alloy. In this case, a quantity of copper of the intermediate layer 130 may be reduced by a quantity corresponding to the alloyed copper. Still more, another under layer may be provided under the nickel layer for another purpose. In this case, even if copper is contained in the under layer formed on the nickel layer, copper formed under the nickel layer barely contributes for the diffusion to the silver layer, i.e., the outermost layer.

(First Mode of Manufacturing Method of Silver-Coated Composite Material for Movable Contact)

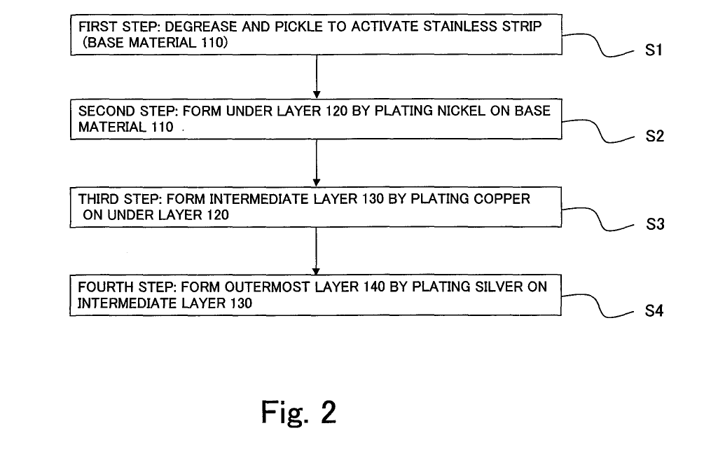

A first mode of a method for manufacturing the silver-coated composite material for movable contact 100 of the first mode will be explained below by using a flowchart shown in FIG. 2. FIG. 2 explains the method of the first mode by exemplifying the silver-coated composite material for movable contact 100.

In the manufacturing method of the present mode, as a first step, a stainless strip that becomes the base material 110 is cathode electrolytic-degreased within an alkaline solution such as orthosilicate soda or caustic soda and is then picked and activated by hydrochloric acid (S1 in FIG. 2).

In the next second step, the under layer 120 is formed by plating nickel by electrolyzing with an electrolytic solution containing nickel chloride and free hydrochloric acid with cathode current density (2 to 5 A/dm²) (S2 in FIG. 2). It is noted that as the electrolytic solution of the nickel plating described above, an electrolytic solution to which nickel sulfamate (100 to 150 g/liter) and boron (20 to 50 g/liter) are added and whose pH is modified within a range from 2.5 to 4.5 may be used.

In the next third step, the intermediate layer 130 is formed by plating copper by electrolyzing with an electrolytic solution containing copper sulfate and free sulfuric acid with 2 to 6 A/dm² of cathode current density (S3 in FIG. 2).

In the final fourth step, the outermost layer 140 is formed by plating silver by electrolyzing with an electrolytic solution containing silver cyanide and potassium cyanide with 2 to 15 A/dm² of cathode current density (S4 in FIG. 2). Thus, the silver-coated composite material for movable contact 100 may be manufactured through the process from the first step S1 to the fourth step S4.

It is noted that in the second step S2 for forming the under layer 120, nickel alloy plating may be also implemented, instead of the nickel plating described above, by electrolyzing by adding cobalt chloride to the electrolytic solution containing nickel chloride and free hydrochloric acid with 2 to 15 A/dm² of cathode current density. Still more, in the third step S3 for faulting the intermediate layer 130, copper alloy (copper-zinc alloy or copper-tin alloy) plating may be implemented by electrolyzing by adding zinc cyanide or potassium stannate to the electrolytic solution containing copper cyanide and potassium cyanide with 2 to 15 A/dm² of cathode current density.

Still more, prior to the third step S3 or an alternate step of the third step S3, copper strike plating may be implemented by electrolyzing with an electrolytic solution containing copper sulfate and free sulfuric acid with 1 to 3 A/dm² of cathode current density. Beside improving the adhesion between the under layer 120 and the intermediate layer 130, the intermediate layer 130 is formed minutely by implementing the copper strike plating at least to the part of the intermediate layer 130 contacting with the under layer 120, so that the outermost layer 140 to be formed thereafter is also formed minutely and it becomes possible to prevent the surface roughness of the interface of the respective layers from becoming so large that otherwise causes cracks during press working and the like. That is, the effect of preventing cracks of the respective layers during press working is exhibited further by implementing the copper strike plating.

Still more, in the final fourth step of forming the outermost layer 140, silver alloy (silver—antimony alloy) may be plated instead of the silver plating described above by electrolyzing by adding antimonyl potassium tartrate to the electrolytic solution containing silver cyanide and potassium cyanide with 2 to 5 A/dm² of cathode current density. Or, after plating copper or copper alloy in the third step S3, silver strike plating may be implemented by electrolyzing with the electrolytic solution containing silver cyanide and potassium cyanide with 1 to 5 A/dm² of cathode current density and then the silver plating or the silver alloy plating may be implemented.

(First Embodiment of Manufacturing Method of First Mode)

The manufacturing method of the first mode for manufacturing the silver-coated composite material for movable contact 100 of the first mode will be explained in detail further by using a first embodiment.

In the first embodiment described below, a strip shape stainless steel SUS301 (referred to as the SUS301 strip hereinafter) will be used as the base material 110. The dimension of the SUS301 strip is 0.06 mm thick and 100 mm strip width. In a plating line that continuously threads and winds up the SUS301 strip, the first step of electrolytic-degreasing, pickling and electrolytic-activating the SUS301 strip, the second step of implementing the nickel plating (or nickel-cobalt plating) and washing, a third step of implementing the copper plating and washing and the fourth step of the silver strike plating, silver plating, washing and drying are respectively carried out.

The followings are the processing conditions of each step.

1. First Step (Electrolytic Degreasing, Electrolytic Activation)

The stainless strip is cathode electrolytic-degreased within aqueous solution of 70 to 150 g/liter (100 g/liter in the present embodiment) of orthosilicate soda or 50 to 100 g/liter (70 g/liter in the present embodiment) of caustic soda and is then pickled by 10% hydrochloric acid to activate it.

2. Second Step:

### (1) In Case of Nickel Plating:

Plating is implemented by electrolyzing with an electrolytic solution containing 10 to 50 g of nickel chloride hexahydrate (25 g/liter in the present embodiment) and 30 to 100 g of free hydrochloric acid (50 g/liter in the present embodiment) with 2 to 5 A/dm² of cathode current density (3 A/dm² in the present embodiment).

### (2) In Case of Nickel Alloy Plating:

Plating is implemented by adding cobalt chloride hexahydrate or secondary copper chloride dehydrate into the plating solution described above so that cobalt ion concentration or copper ion concentration within the plating solution corresponds to 5 to 20% of concentration (10% in the present embodiment) in which nickel ion and cobalt ion or copper ion are added.

3. Third Step:

### (1) In Case of Copper Strike Plating:

Plating is implemented by electrolyzing with an electrolytic solution containing 10 to 30 g of copper sulfate pentahydrate (15 g/liter in the present embodiment) and 50 to 150 g of free sulfuric acid (100 g/liter in the present embodiment) with 1 to 3 A/dm² of cathode current density (2 A/dm² in the present embodiment).

### (2) In Case of Copper Plating:

Plating is implemented by electrolyzing with an electrolytic solution containing 10 to 30 g of copper sulfate pentahydrate (15 g/liter in the present embodiment) and 50 to 150 g of free sulfuric acid (100 g/liter in the present embodiment) with 1 to 3 A/dm² of cathode current density (2 A/dm² in the present embodiment).

### (3) In Case of Copper Alloy Plating:

Plating is implemented by electrolyzing by adding 0.2 to 0.4 g of zinc cyanide (0.3 g/liter in the present embodiment) or 0.5 to 2 g potassium stannate (1 g/liter in the present embodiment) based on the electrolytic solution containing 30 to 70 g copper cyanide (50 g/liter in the present embodiment), 50 to 100 g of potassium cyanide (75 g/liter in the present embodiment) and 30 to 50 g of potassium hydrate (40 g/liter in the present embodiment) with 2 to 15 A/dm² of cathode current density (3 A/dm² in the present embodiment).

4. Fourth Step:

### (1) In Case of Silver Strike Plating:

Plating is implemented by electrolyzing with an electrolytic solution containing 3 to 7 g of silver cyanide (5 g/liter in the present embodiment) and 30 to 70 g of potassium cyanide (50 g/liter in the present embodiment) with 1 to 3 A/dm² of cathode current density (2 A/dm² in the present embodiment).

### (2) In Case of Silver Plating:

Plating is implemented by electrolyzing with an electrolytic solution containing 30 to 100 g of silver cyanide (50 g/liter in the present embodiment) and 30 to 100 g of potassium cyanide (50 g/liter in the present embodiment) with 2 to 15 A/dm² of cathode current density (5 A/dm² in the present embodiment). It is noted that 20 to 40 g/liter of potassium carbonate (30 g/litter in the present embodiment) may be added as necessary.

### (3) In Case of Silver Alloy Plating:

Plating is implemented by electrolyzing by adding 0.3 to 1 g/liter (0.6 h in the present embodiment) of antimonyl potassium tartrate to the electrolytic solution described above.

Table 1 shows samples of the first embodiment in which thicknesses of the under layer 120, the intermediate layer 130 and the outermost layer 140 are changed variously. It is noted that heat treatment of two hours at 250° C. within argon (Ar) gas atmosphere was carried out on the sample Nos. 49 through 52 of the embodiment shown in Table 1.

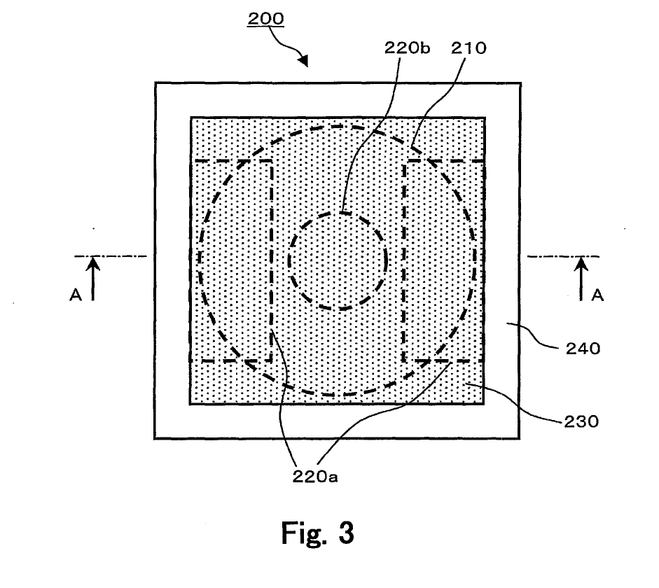

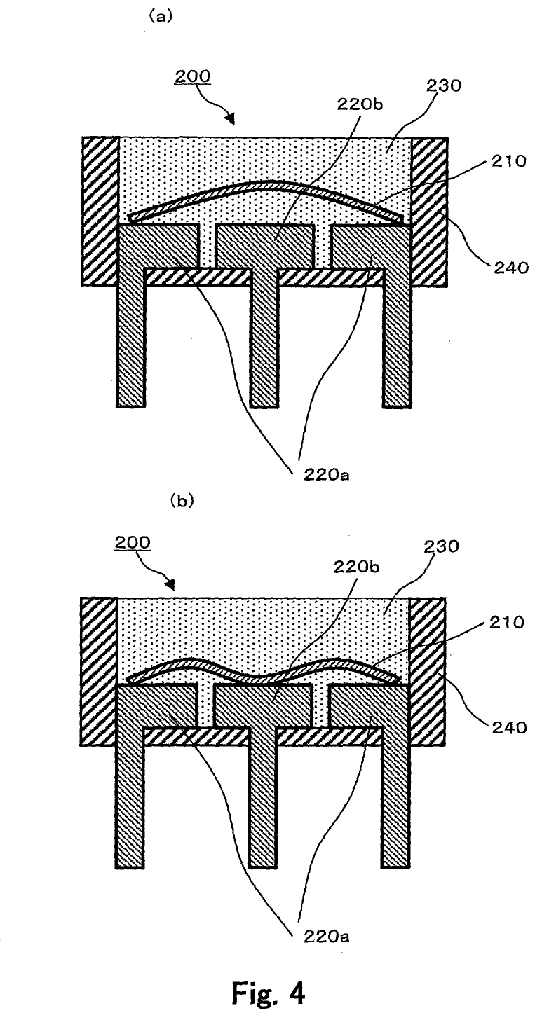

A switch 200 shown in FIGS. 3 and 4 was made by using the silver-coated composite material for movable contacts in Table 1 manufactured under the processing conditions described above. FIG. 3 is a plan view of the switch 200 and FIG. 4 is a section view of the switch 200 taken along a line A-A in FIG. 3.

A domed movable contact 210 shown in FIGS. 3 and 4 is formed to have a diameter of 4 mm by using the silver-coated composite material for movable contact of the embodiment shown in Table 1. Fixed contacts 220a and 220b are formed by plating silver of 1 μm thick on a brass strip. The domed movable contact 210 is coated by a resin filler 230 and is stored within a resin case 240 together with the fixed contacts 220. The switch 200 is arranged to be On-state when the domed movable contact 210 shown in FIG. 4A is convex above and be Off-state when the domed movable contact 210 is pressed down and electrically connects the fixed contacts 220a and 220b as shown in FIG. 4B.

A keying test was carried out by repeating the On/Off states shown in FIGS. 4A and 4B by using the switch 200 constructed as described above. During the keying test, keying of 2 million times in maximum is carried out with 9.8 N/mm² of contact pressure and 5 Hz of keying speed. Table 2 shows measured results of temporal changes of contact resistance during the keying test of the domed movable contact 210, representing initial values, after keying by 1 million times (After Keying 1) and after keying by 2 million times (After Keying 2), respectively. It was also observed whether or not the domed movable contact 210 generated cracks after finishing the keying test of 2 million times and Table 2 also shows its results. It is noted that the value of the contact resistance is considered to be practically permissible if it is less than 100 mΩ.

A heating test was carried out on all of the samples by heating for 1,000 hours in air bath at 85° C. Changes of the contact resistance were measured and Table 2 shows its results.

TABLE 1

| | | OUTERMOST | | INTERMEDIATE | | | | INTERMEDIATE + |
|---|---|---|---|---|---|---|---|---|
| | SAMPLE | LAYER | | LAYER | | UNDER LAYER | | UNDER |
| | No. | SPECIES | THICK (μm) | SPECIES | THICK (μm) | SPECIES | THICK (μm) | TOTAL THICK (μm) |
| EMBODIMENT | 1 | Ag | 1.0 | Cu | 0.15 | Ni | 0.040 | 0.190 |
| | 2 | Ag | 1.0 | Cu | 0.10 | Ni | 0.040 | 0.140 |
| | 3 | Ag | 1.0 | Cu | 0.04 | Ni | 0.040 | 0.080 |
| | 4 | Ag | 1.0 | Cu | 0.02 | Ni | 0.040 | 0.060 |
| | 5 | Ag | 1.0 | Cu | 0.15 | Ni | 0.030 | 0.180 |
| | 6 | Ag | 1.0 | Cu | 0.10 | Ni | 0.030 | 0.130 |
| | 7 | Ag | 1.0 | Cu | 0.04 | Ni | 0.030 | 0.070 |
| | 8 | Ag | 1.0 | Cu | 0.02 | Ni | 0.030 | 0.050 |
| | 9 | Ag | 1.0 | Cu | 0.15 | Ni | 0.020 | 0.170 |
| | 10 | Ag | 1.0 | Cu | 0.10 | Ni | 0.020 | 0.120 |
| | 11 | Ag | 1.0 | Cu | 0.04 | Ni | 0.020 | 0.060 |
| | 12 | Ag | 1.0 | Cu | 0.02 | Ni | 0.020 | 0.040 |
| | 13 | Ag | 1.0 | Cu | 0.15 | Ni | 0.012 | 0.162 |
| | 14 | Ag | 1.0 | Cu | 0.10 | Ni | 0.012 | 0.112 |
| | 15 | Ag | 1.0 | Cu | 0.04 | Ni | 0.012 | 0.052 |
| | 16 | Ag | 1.0 | Cu | 0.02 | Ni | 0.012 | 0.032 |
| | 17 | Ag | 1.0 | Cu | 0.15 | Ni | 0.009 | 0.159 |
| | 18 | Ag | 1.0 | Cu | 0.10 | Ni | 0.009 | 0.109 |
| | 19 | Ag | 1.0 | Cu | 0.04 | Ni | 0.009 | 0.049 |
| | 20 | Ag | 1.0 | Cu | 0.02 | Ni | 0.009 | 0.029 |
| | 21 | Ag | 1.0 | Cu | 0.15 | Ni | 0.005 | 0.155 |
| | 22 | Ag | 1.0 | Cu | 0.10 | Ni | 0.005 | 0.105 |
| | 23 | Ag | 1.0 | Cu | 0.04 | Ni | 0.005 | 0.045 |
| | 24 | Ag | 1.0 | Cu | 0.02 | Ni | 0.005 | 0.025 |
| | 25 | Ag | 0.5 | Cu | 0.10 | Ni | 0.040 | 0.140 |
| | 26 | Ag | 0.5 | Cu | 0.04 | Ni | 0.040 | 0.080 |
| | 27 | Ag | 0.5 | Cu | 0.10 | Ni | 0.030 | 0.130 |
| | 28 | Ag | 0.5 | Cu | 0.04 | Ni | 0.030 | 0.070 |
| | 29 | Ag | 0.5 | Cu | 0.10 | Ni | 0.020 | 0.120 |
| | 30 | Ag | 0.5 | Cu | 0.04 | Ni | 0.020 | 0.060 |
| | 31 | Ag | 0.5 | Cu | 0.10 | Ni | 0.012 | 0.112 |
| | 32 | Ag | 0.5 | Cu | 0.04 | Ni | 0.012 | 0.052 |
| | 33 | Ag | 0.5 | Cu | 0.10 | Ni | 0.009 | 0.109 |
| | 34 | Ag | 0.5 | Cu | 0.04 | Ni | 0.009 | 0.049 |
| | 35 | Ag | 0.5 | Cu | 0.10 | Ni | 0.005 | 0.105 |
| | 36 | Ag | 0.5 | Cu | 0.04 | Ni | 0.005 | 0.045 |
| | 37 | Ag | 1.5 | Cu | 0.10 | Ni | 0.040 | 0.140 |
| | 38 | Ag | 1.5 | Cu | 0.04 | Ni | 0.040 | 0.080 |
| | 39 | Ag | 1.5 | Cu | 0.10 | Ni | 0.030 | 0.130 |
| | 40 | Ag | 1.5 | Cu | 0.04 | Ni | 0.030 | 0.070 |
| | 41 | Ag | 1.5 | Cu | 0.10 | Ni | 0.020 | 0.120 |
| | 42 | Ag | 1.5 | Cu | 0.04 | Ni | 0.020 | 0.060 |
| | 43 | Ag | 1.5 | Cu | 0.10 | Ni | 0.012 | 0.112 |
| | 44 | Ag | 1.5 | Cu | 0.04 | Ni | 0.012 | 0.052 |
| | 45 | Ag | 1.5 | Cu | 0.10 | Ni | 0.009 | 0.109 |
| | 46 | Ag | 1.5 | Cu | 0.04 | Ni | 0.009 | 0.049 |
| | 47 | Ag | 1.5 | Cu | 0.10 | Ni | 0.005 | 0.105 |
| | 48 | Ag | 1.5 | Cu | 0.04 | Ni | 0.005 | 0.045 |
| | 49 | Ag | 1.0 | Cu | 0.10 | Ni | 0.040 | 0.140 |
| | 50 | Ag | 1.0 | Cu | 0.10 | Ni | 0.009 | 0.109 |
| | 51 | Ag | 1.0 | Cu | 0.04 | Ni | 0.040 | 0.080 |
| | 52 | Ag | 1.0 | Cu | 0.04 | Ni | 0.009 | 0.049 |
| COMPARATIVE | 101 | Ag | 1.0 | Cu | 0.01 | Ni | 0.009 | 0.019 |
| EXAMPLE | 102 | Ag | 1.0 | Cu | 0.10 | Ni | 0.050 | 0.150 |
| | 103 | Ag | 1.0 | Cu | 0.30 | Ni | 0.050 | 0.350 |
| | 104 | Ag | 1.0 | Cu | 0.10 | Ni | 0.100 | 0.200 |
| | 105 | Ag | 1.0 | Cu | 0.30 | Ni | 0.100 | 0.400 |
| | 106 | Ag | 1.0 | Cu | 0.01 | Ni | 0.300 | 0.310 |
| | 107 | Ag | 1.0 | Cu | 0.10 | Ni | 0.300 | 0.400 |
| | 108 | Ag | 1.0 | Cu | 0.30 | Ni | 0.300 | 0.600 |

TABLE 2

| | | | | | | | | APPEARANCE AFTER | |
|---|---|---|---|---|---|---|---|---|---|
| | | | | CONTACT RESISTANCE (mΩ) | | | | KEYING 2 | |
| | SAMPLE | TREATED | PROC- | INITIAL | AFTER | AFTER | HEATING | UNDERLAYER | |
| | No. | BY HEAT? | ESSABILITY | VALUE | KEYING 1 | KEYING 2 | TEST | EXPOSED? | CRACK |
| EMBODIMENT | 1 | none | ◯ | 11 | 16 | 49 | 89 | none | none |
| | 2 | none | ◯ | 12 | 16 | 42 | 76 | none | none |
| | 3 | none | ◯ | 12 | 16 | 38 | 62 | none | none |
| | 4 | none | ◯ | 12 | 16 | 37 | 55 | none | none |
| | 5 | none | ◯ | 10 | 15 | 46 | 92 | none | none |
| | 6 | none | ◯ | 10 | 14 | 39 | 78 | none | none |
| | 7 | none | ◯ | 10 | 14 | 35 | 65 | none | none |
| | 8 | none | ◯ | 11 | 15 | 35 | 58 | none | none |
| | 9 | none | ◯ | 10 | 15 | 44 | 94 | none | none |
| | 10 | none | ◯ | 10 | 14 | 38 | 79 | none | none |
| | 11 | none | ◯ | 11 | 15 | 34 | 66 | none | none |
| | 12 | none | ◯ | 11 | 15 | 33 | 59 | none | none |
| | 13 | none | ◯ | 10 | 14 | 41 | 96 | none | none |
| | 14 | none | ◯ | 10 | 14 | 36 | 80 | none | none |
| | 15 | none | ◯ | 11 | 14 | 32 | 65 | none | none |
| | 16 | none | ◯ | 11 | 15 | 32 | 59 | none | none |
| | 17 | none | ⊚ | 10 | 14 | 35 | 97 | none | none |
| | 18 | none | ⊚ | 10 | 14 | 29 | 80 | none | none |
| | 19 | none | ⊚ | 10 | 14 | 25 | 64 | none | none |
| | 20 | none | ⊚ | 10 | 14 | 24 | 58 | none | none |
| | 21 | none | ⊚ | 9 | 14 | 31 | 97 | none | none |
| | 22 | none | ⊚ | 10 | 14 | 27 | 80 | none | none |
| | 23 | none | ⊚ | 10 | 14 | 24 | 64 | none | none |
| | 24 | none | ⊚ | 10 | 14 | 23 | 58 | none | none |
| | 25 | none | ◯ | 13 | 18 | 48 | 78 | none | none |
| | 26 | none | ◯ | 13 | 18 | 43 | 64 | none | none |
| | 27 | none | ◯ | 13 | 18 | 47 | 79 | none | none |
| | 28 | none | ◯ | 13 | 18 | 42 | 66 | none | none |
| | 29 | none | ◯ | 12 | 18 | 45 | 80 | none | none |
| | 30 | none | ◯ | 12 | 18 | 41 | 67 | none | none |
| | 31 | none | ◯ | 12 | 18 | 44 | 81 | none | none |
| | 32 | none | ◯ | 12 | 18 | 40 | 68 | none | none |
| | 33 | none | ⊚ | 12 | 17 | 39 | 80 | none | none |
| | 34 | none | ⊚ | 12 | 17 | 36 | 67 | none | none |
| | 35 | none | ⊚ | 12 | 17 | 38 | 80 | none | none |
| | 36 | none | ⊚ | 12 | 17 | 35 | 67 | none | none |
| | 37 | none | ◯ | 10 | 14 | 39 | 75 | none | none |
| | 38 | none | ◯ | 10 | 14 | 35 | 63 | none | none |
| | 39 | none | ◯ | 10 | 14 | 37 | 76 | none | none |
| | 40 | none | ◯ | 10 | 14 | 33 | 64 | none | none |
| | 41 | none | ◯ | 10 | 14 | 36 | 77 | none | none |
| | 42 | none | ◯ | 10 | 14 | 32 | 64 | none | none |
| | 43 | none | ◯ | 10 | 14 | 27 | 77 | none | none |
| | 44 | none | ◯ | 10 | 15 | 27 | 65 | none | none |
| | 45 | none | ⊚ | 9 | 12 | 20 | 76 | none | none |
| | 46 | none | ⊚ | 9 | 12 | 20 | 64 | none | none |
| | 47 | none | ⊚ | 9 | 12 | 20 | 76 | none | none |
| | 48 | none | ⊚ | 9 | 12 | 19 | 64 | none | none |
| | 49 | yes | ◯ | 14 | 17 | 33 | 49 | none | none |
| | 50 | yes | ⊚ | 14 | 17 | 30 | 48 | none | none |
| | 51 | yes | ◯ | 13 | 16 | 24 | 36 | none | none |
| | 52 | yes | ⊚ | 13 | 15 | 22 | 36 | none | none |
| COMPARATIVE | 101 | none | X | 15 | 50 | 560 | 60 | none | yes |
| EXAMPLE | 102 | none | Δ | 12 | 18 | 125 | 75 | none | yes |
| | 103 | none | Δ | 13 | 35 | 330 | 820 | none | yes |
| | 104 | none | X | 14 | 20 | 145 | 72 | none | yes |
| | 105 | none | X | 15 | 44 | 420 | 760 | none | yes |
| | 106 | none | X | 16 | 36 | 510 | 125 | yes | yes |
| | 107 | none | X | 16 | 30 | 170 | 162 | yes | yes |
| | 108 | none | X | 17 | 61 | 750 | 1250 | yes | yes |

The increase of the contact resistance of all of the sample Nos. 1 through 52 of the embodiment shown in Table 1 was small even after the keying test of 2 million times and no exposure of the under layer 120 and the intermediate layer 130 was seen in the contact point after keying 2 million times as shown in Table 2. Still more, the increase of the contact resistance was small even after heating for 1,000 hours and the value of the contact resistance of all of the sample Nos. 1 through 52 was less than 100 mΩ, which is practically no problem.

However, the sample No. 101 of a comparative example (see Table 1) in which a total thickness of the under layer 120 and the intermediate layer 130 is less than 0.025 μm deteriorates its workability due to the drop of the adhesion of the respective layers and the sample Nos. 102 through 108 (see Table 1) in which the thickness of the under layer 120 exceeds the upper limit of the range of the invention (0.05 μm or more) have a tendency to deteriorate their workability. Still more, an increase of the contact resistance considered to be caused by deteriorated workability (specifically, the state in which the value of the contact resistance exceeds 100 mΩ) is detected in the sample Nos. 101 through 108 of the comparative examples after keying by 2 million times.

Still more, crack which is considered to be caused by inferior workability was found in the contact part of the sample Nos. 101 through 108 of the comparative example and the outermost layer of the contact part peeled and the under layer was exposed in the sample Nos. 106 through 108 of the comparative example whose under layer 120 is 0.3 μm thick.

Meanwhile, the contact resistance remarkably increased (to the state in which the value of the contact resistance exceeds 100 mΩ in concrete) after the heating test and cracks were seen after the keying test in the sample Nos. 103, 105 and 108 (see Table 1) whose intermediate layer 120 is 0.3 μm thick.

(Second Embodiment of Manufacturing Method of First Mode)

The manufacturing method of the first mode for manufacturing the silver-coated composite material for movable contact 100 will be explained in detail further by using a second embodiment.

About the under layer 120: When nickel alloy plating in which 10 mass % of nickel is replaced with copper or cobalt was used and tested in the same manner with the sample Nos. 1 through 52 and sample Nos. 101 through 108 in Table 1, the test result was substantially the same with the results shown in Table 2. The same also applies to a case when nickel is completely replaced with cobalt.

About the intermediate layer 130: When copper alloy plating in which 0.5 mass % of copper is replaced with tin or zinc was used and tested in the same manner with the sample Nos. 1 through 52 and sample Nos. 101 through 108 in Table 1, the test result was substantially the same with the results shown in Table 2.

About the outermost layer 140: When silver alloy plating in which 1 mass % of silver is replaced with antimony was used and tested in the same manner with the sample Nos. 1 through 52 and sample Nos. 101 through 108 in Table 1, the test result was substantially the same with the results shown in Table 2.

Still more, when the respective samples in the embodiment shown in Table 1 were appropriately combined, the test results were substantially the same with the results shown in Table 2.

(Second Mode of Manufacturing Method of Silver-Coated Composite Material for Movable Contact)

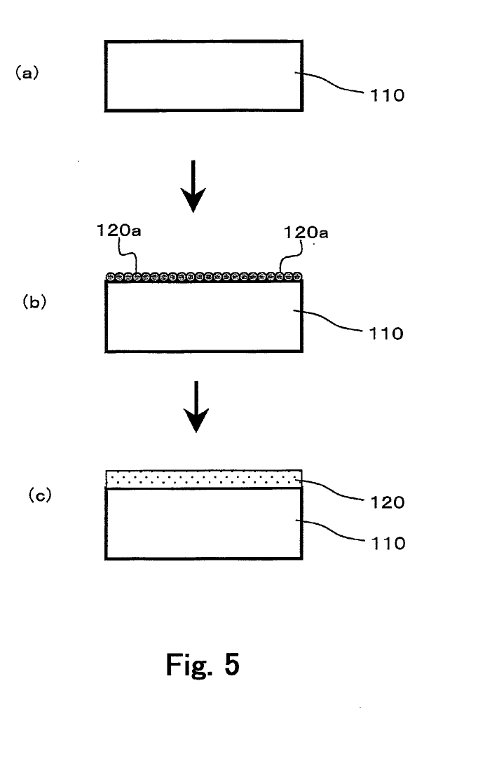

Next, a second mode of the manufacturing method for manufacturing the silver-coated composite material for movable contact 100 shown in FIG. 1 (manufacturing method of the second mode) will be explained with reference to FIGS. 5A through 5C.

The manufacturing method of the silver-coated composite material for movable contact of the present mode has the following steps.

(First Step) The base material (base material of the metal strip) 110 which is a stainless strip composed of an alloy whose main component is iron or nickel is electrolytic-degreased and then activated by pickling by an acid solution containing nickel ion to form the under layer 120 which is composed of nickel and whose thickness is less than 0.04 μm on the base material 110.

The activation process for activating the base material 110 is carried out under the following conditions for example in this first step.

(1) As the acid solution containing nickel ion, an acid solution to which 120 g/liter of free hydrochloric acid and 12 g/liter of nickel chloride hexahydrate are added is used. It is noted that as the acid solution containing nickel ion, it is preferable to add free hydrochloric acid in a range of 80 to 200 g/liter (or more preferably 100 to 150 g/liter) and nickel chloride hexahydrate in a range of 5 to 20 g/liter (or more preferably 10 to 15 g/liter). When the additive amounts of free hydrochloric acid and nickel chloride hexahydrate are out of those ranges, the adhesion between the base material and the under layer tends to drop in all of the cases.

(2) The cathode current density during the activation process is set at 3.5 (A/dm²). It is noted that the cathode current density during the activation process is preferable to be in a range of 2.0 to 5.0 (A/dm²) and is more preferable to be in a range of 3.0 to 5.0 (A/dm²) from the aspect of flattening the under layer. A still more preferable range is 3.0 to 4.0 (A/dm²). When the cathode current density during the activation process is less than 2.0 (A/dm²), it is not preferable because the adhesion between the base material and the under layer tends to drop. Still more, when the cathode current density during the activation process is higher than 5.0 (A/dm²), it is also not so preferable because there is a case when an influence of generated heat of the base material is brought out when the base material is stainless steel.

By carrying out the activation process of the base material 110 shown in FIG. 5A under such conditions, nucleuses 120a of nickel (Ni) are formed minutely without gap on the whole surface of the base material 110 (see FIG. 5B) and the under layer 120 whose thickness is less than 0.04 μm is formed on the whole surface of the base material 110 (see FIG. 5C). It is noted that while the under layer 120 composed of nickel is formed by the activation process in the present mode, the activation process of the base material 110 is carried out by an acid solution containing cobalt ion in the first step described above in foaming the under layer composed of cobalt by the similar activation process.

(Second Step) The intermediate layer 130 is formed on the under layer 120 by plating copper by electrolyzing with an electrolytic solution containing copper sulfate and free sulfuric acid with 5 A/dm² of cathode current density.

(Third Step) The outermost layer 140 is formed on the intermediate layer 130 by plating silver by electrolyzing with an electrolytic solution containing silver cyanide and potassium cyanide.

Thus, the under layer 120 whose thickness is less than 0.04 μm is formed on the whole surface of the base material 110 during the activation process of activating by pickling the base material 110 with the acid solution containing nickel ion after electrolytic-degreasing it in the manufacturing method of the silver-coated composite material for movable contact of the present mode. Therefore, it becomes unnecessary to carry out the step of nickel plating or nickel alloy plating for forming the under layer 120 (S2 in FIG. 2) in the manufacturing method of the silver-coated composite material for movable contact of the first mode described above by using FIG. 2. Accordingly, the manufacturing step is simplified and operation time may be shortened, so that the silver-coated composite material for movable contact may be manufactured at low cost.

Still more, the under layer 120 whose thickness less than 0.04 μm may be formed on the base material 110 during the activation process of the base material 110 composed of stainless steel. Forming the under layer 120 as described above allows not only the adhesion between the base material 110 and the under layer 120 to be improved, but also the adhesion between the under layer 120 and the intermediate layer 130 to be improved and the long-life silver-coated composite material for movable contact to be obtained.

As samples manufactured by the manufacturing method of the second mode described above, samples in which thicknesses of the under layer 120, the intermediate layer 130 and the outermost layer 140 are changed variously in the same manner with the samples of the embodiment respectively shown in Table 1 were prepared and represented as sample Nos. 201 through 252 (see Table 3). It is noted that heat treatment of two hours at 250° C. within argon (Ar) gas atmosphere was carried out on the sample Nos. 249 through 252 of the embodiment shown in Table 3. Still more, sample Nos. 301 through 308 (see Table 3) were prepared as comparative examples. It is noted that the sample Nos. 201 through 252 are samples respectively having the same layer structure with the sample Nos. 1 through 52 in Table 1 and the sample Nos. 301 through 308 of the comparative examples shown in Table 3 are samples respectively having the same layer structure with those of the sample Nos. 101 through 108 of the comparative examples shown in Table 3. Their correspondence relationship is made such that the sample No. of the embodiment shown in Table 1 added with 200 is the sample No. of the embodiment shown in Table 3.

A switch similar to the switch 200 having the structure as shown in FIGS. 3 and 4 was made by using the is brought out when 201 through 252 manufactured under the processing conditions described above and the sample Nos. 301 through 308. The other conditions were the same with those of the case when the silver-coated composite material for movable contacts of the sample Nos. 1 through 52 and the sample Nos. 101 through 108 described above were used.

A keying test was carried out by repeating the On/Off states shown in FIGS. 4A and 4B by using the switch constructed as described above. During the keying test, keying of 2 million times in maximum is carried out with 9.8 N/mm² of contact pressure and 5 Hz of keying speed. Table 3 shows measured results of temporal changes of contact resistance during the keying test of the domed movable contact 210, representing initial values, after keying by 1 million times (After Keying 1) and after keying by 2 million times (After Keying 2), respectively. It was also observed whether or not the domed movable contact 210 generated cracks after finishing the keying test of 2 million times and Table 3 also shows its results.

A heating test was carried out on all of the samples by heating for 1,000 hours in air bath at 85° C. Changes of the contact resistance were measured and Table 3 shows its result.

TABLE 3

| | | | | CONTACT RESISTANCE (mΩ) | | | | APPEARANCE AFTER | |
|---|---|---|---|---|---|---|---|---|---|
| | | | | | | | AFTER | KEYING 2 | |
| | SAMPLE | TREATED | PROC- | INITIAL | AFTER | AFTER | HEATING | UNDERLAYER | |
| | No. | BY HEAT? | ESSABILITY | VALUE | KEYING 1 | KEYING 2 | TEST | EXPOSED? | CRACK |
| EMBODIMENT | 201 | none | ◯ | 11 | 12 | 16 | 16 | none | none |
| | 202 | none | ◯ | 12 | 12 | 16 | 15 | none | none |
| | 203 | none | ◯ | 12 | 12 | 16 | 15 | none | none |
| | 204 | none | ◯ | 12 | 12 | 15 | 15 | none | none |
| | 205 | none | ◯ | 10 | 11 | 16 | 14 | none | none |
| | 206 | none | ◯ | 10 | 11 | 16 | 14 | none | none |
| | 207 | none | ◯ | 10 | 11 | 15 | 14 | none | none |
| | 208 | none | ◯ | 11 | 11 | 16 | 15 | none | none |
| | 209 | none | ◯ | 10 | 11 | 16 | 15 | none | none |
| | 210 | none | ◯ | 10 | 11 | 16 | 14 | none | none |
| | 211 | none | ◯ | 11 | 11 | 16 | 14 | none | none |
| | 212 | none | ◯ | 11 | 12 | 17 | 15 | none | none |
| | 213 | none | ◯ | 10 | 11 | 16 | 14 | none | none |
| | 214 | none | ◯ | 10 | 11 | 16 | 14 | none | none |
| | 215 | none | ◯ | 11 | 12 | 16 | 15 | none | none |
| | 216 | none | ◯ | 11 | 12 | 16 | 15 | none | none |
| | 217 | none | ⊚ | 10 | 11 | 15 | 14 | none | none |
| | 218 | none | ⊚ | 10 | 11 | 15 | 14 | none | none |
| | 219 | none | ⊚ | 10 | 11 | 15 | 14 | none | none |
| | 220 | none | ⊚ | 10 | 11 | 15 | 14 | none | none |
| | 221 | none | ⊚ | 9 | 10 | 14 | 13 | none | none |
| | 222 | none | ⊚ | 10 | 10 | 14 | 14 | none | none |
| | 223 | none | ⊚ | 10 | 11 | 13 | 13 | none | none |
| | 224 | none | ⊚ | 10 | 11 | 14 | 14 | none | none |
| | 225 | none | ◯ | 13 | 15 | 20 | 25 | none | none |
| | 226 | none | ◯ | 13 | 15 | 20 | 23 | none | none |
| | 227 | none | ◯ | 13 | 15 | 20 | 25 | none | none |
| | 228 | none | ◯ | 13 | 15 | 20 | 23 | none | none |
| | 229 | none | ◯ | 12 | 14 | 20 | 24 | none | none |
| | 230 | none | ◯ | 12 | 14 | 19 | 23 | none | none |
| | 231 | none | ◯ | 12 | 14 | 20 | 23 | none | none |
| | 232 | none | ◯ | 12 | 14 | 19 | 22 | none | none |
| | 233 | none | ⊚ | 12 | 14 | 20 | 23 | none | none |
| | 234 | none | ⊚ | 12 | 14 | 19 | 21 | none | none |
| | 235 | none | ⊚ | 12 | 14 | 20 | 23 | none | none |
| | 236 | none | ⊚ | 12 | 14 | 19 | 22 | none | none |
| | 237 | none | ◯ | 10 | 11 | 13 | 13 | none | none |
| | 238 | none | ◯ | 10 | 11 | 13 | 13 | none | none |
| | 239 | none | ◯ | 10 | 11 | 12 | 13 | none | none |
| | 240 | none | ◯ | 10 | 11 | 12 | 13 | none | none |
| | 241 | none | ◯ | 9 | 10 | 12 | 12 | none | none |
| | 242 | none | ◯ | 9 | 10 | 12 | 13 | none | none |
| | 243 | none | ◯ | 9 | 10 | 11 | 12 | none | none |
| | 244 | none | ◯ | 9 | 10 | 11 | 13 | none | none |
| | 245 | none | ⊚ | 9 | 10 | 11 | 12 | none | none |
| | 246 | none | ⊚ | 9 | 10 | 11 | 13 | none | none |
| | 247 | none | ⊚ | 9 | 9 | 11 | 12 | none | none |
| | 248 | none | ⊚ | 9 | 9 | 10 | 12 | none | none |
| | 249 | yes | ◯ | 14 | 15 | 18 | 16 | none | none |
| | 250 | yes | ⊚ | 14 | 14 | 17 | 16 | none | none |
| | 251 | yes | ◯ | 13 | 14 | 16 | 16 | none | none |
| | 252 | yes | ⊚ | 13 | 14 | 16 | 16 | none | none |
| COMPARATIVE | 301 | none | X | 15 | 50 | 380 | 48 | none | yes |
| EXAMPLE | 302 | none | Δ | 12 | 18 | 35 | 58 | none | yes |
| | 303 | none | Δ | 13 | 35 | 240 | 630 | none | yes |
| | 304 | none | X | 14 | 20 | 36 | 54 | none | yes |
| | 305 | none | X | 15 | 44 | 300 | 570 | none | yes |
| | 306 | none | X | 16 | 36 | 360 | 95 | yes | yes |
| | 307 | none | X | 16 | 30 | 120 | 131 | yes | yes |
| | 308 | none | X | 17 | 61 | 520 | 920 | yes | yes |

The increase of the contact resistance of all of the sample Nos. 201 through 252 of the embodiment shown in Table 3 was small even after the keying test of 2 million times and no exposure of the under layer 120 and the intermediate layer 130 was seen in the contact point after keying 2 million times. Still more, the increase of the contact resistance was small even after heating for 1,000 hours. Specifically, it was found that the increase of the contact resistance after the keying test of 2 million times and the increase of the contact resistance after heating for 1,000 hours of the sample Nos. 201 through 252 shown in Table 3 were small as compared to those of the sample Nos. 1 through 52 of the embodiment shown in Table 1, that the value of the contact resistance of all of the samples in Table 3 is less than 30 mΩ and that the performance as a material of the contact is very excellent. It is noted that the various modifications explained in the first and second embodiments of the manufacturing method of the first mode are applicable to the manufacturing method of the second mode.

(Second Mode of Silver-Coated Composite Material for Movable Contact)

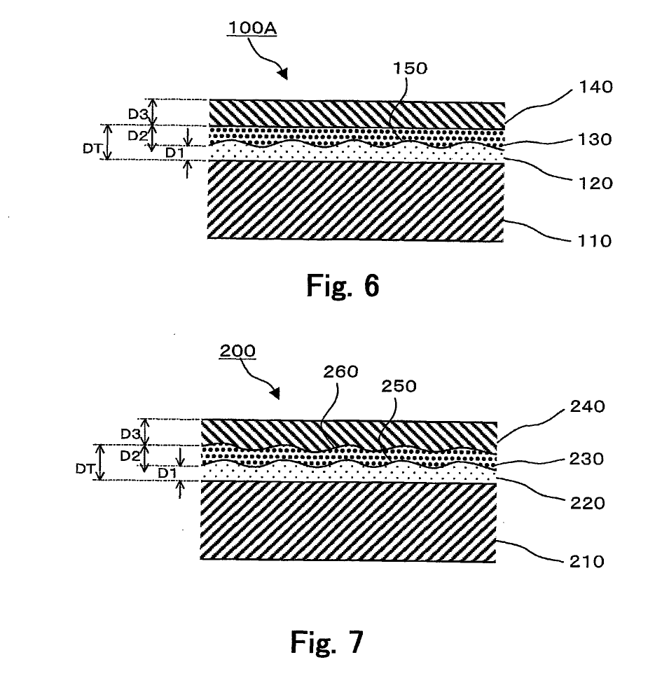

A second mode of the silver-coated composite material for movable contact of the invention will be explained by using a section view shown in FIG. 6. The silver-coated composite material for movable contact 100A of the present mode includes a base material 110 composed of an alloy whose main component is iron or nickel, an under layer 120 formed at least on part of the surface of the base material 110, an intermediate layer 130 formed on the under layer 120 and an outermost layer 140 formed on the intermediate layer 130. Since the present mode has parts in common with the first mode of the silver-coated composite material for movable contact described above, the present mode will be explained centering on their differences.

While nickel, cobalt or alloy whose main component is nickel or cobalt (the whole mass ratio is 50 mass % or more) is used as metal forming the under layer 120, it is preferable to use nickel among them. The under layer 120 may be formed by electrolysis by setting the base material 110 composed of stainless steel at the cathode and by using electrolytic solution containing nickel chloride and free hydrochloric acid for example.

In order to enhance the adhesion between the under layer 120 and the intermediate layer 130, irregularity 150 is formed at their interface in the present mode. A contact area of the under layer 120 and the intermediate layer 130 may be increased by forming the irregularity 150 and the adhesion may be improved by causing mutual diffusion of the both. The interface of the under layer 120 and the intermediate layer 130 is formed to have the wavy irregularity 150 for example in the silver-coated composite material for movable contact 100A shown in FIG. 6.

Still more, in order to suppress the increase of the contact resistance, the preferable thickness of the intermediate layer 130 is determined so that the copper in the intermediate layer 130 does not reach the surface of the outermost layer 140 within the range in which the interlayer adhesions between the surface of the base material 110 and the under layer 120, between the under layer 120 and the intermediate layer 130 and the intermediate layer 130 and the outermost layer 140 in the present mode. An average total thickness DT in which an average thickness D2 of the intermediate layer 130 is added to an average thickness D1 of the under layer 120 is set so as to fall within a range of 0.025 to 0.20 μm in the present mode.

The average value of the thickness of the under layer 120 is preferable to be 0.001 to 0.04 μm. The more preferable thickness is 0.001 to 0.009 μm. It is noted that the case of using nickel as the metal of the under layer 120 will be explained below, the same effect with the following explanation will be obtained even if any of cobalt, nickel alloy and cobalt alloy are used instead of nickel.

Thereby, it becomes possible to suppress the diffusion of copper to the surface of the outermost layer 140 and the oxidation otherwise caused by that while maintaining the high interlayer adhesion. The most desirable form of the outermost layer is the same with the first mode of the silver-coated composite material for movable contact described above.

Although it is preferable to thin the under layer 120 and the intermediate layer 130 from the aspect of improving the workability, the lower limit value of 0.025 μm is set as the total thickness DT of the average thicknesses of the under layer 120 and the intermediate layer 130 because the effect of enhancing the interlayer adhesions between the surface of the base material 110 and the under layer 120, between the under layer 120 and the intermediate layer 130 and between the intermediate layer 130 and the outermost layer 140 drops if the thickness falls below this value. Still more, the upper limit value of 0.20 μm is set for the total thickness DT of the average thickness of the under layer 120 and the average thickness of the intermediate layer 130 because the increase of the contact resistance is prone to occur depending on use environment if the thickness exceeds that value. It is possible to prevent each layer from cracking during pressing by setting the average thickness D1 of the under layer 120 and the average thickness D2 of the intermediate layer 130 within the range described above.

Each layer of the under layer 120, the intermediate layer 130 and the outermost layer 140 of the silver-coated composite material for movable contact 100A of the present mode may be formed by using an arbitrary method such as electro-plating, nonelectrolytic plating, physical and chemical evaporation and others. Specifically, the present mode may be carried out in the same manner with the first mode of the silver-coated composite material for movable contact described above. It is noted that copper may be alloyed to the layers other than the intermediate layer 130 which is composed of copper or copper alloy. Specifically, it may be carried out in the same manner with the first mode of the silver-coated composite material for movable contact described above.

(Third Mode of Silver-Coated Composite Material for Movable Contact)

A third mode of the silver-coated composite material for movable contact of the invention will be explained by using a section view shown in FIG. 7. The switch 200 of the third mode includes a domed movable contact 210 composed of an alloy whose main component is iron or nickel, an under layer 220 formed at least on part of the surface of the domed movable contact 210, an intermediate layer 230 formed on the under layer 220 and an outermost layer 240 formed on the intermediate layer 130 similarly to the silver-coated composite material for movable contact 100A of the second mode shown in FIG. 6.

In order to enhance the adhesion between the under layer 220 and the intermediate layer 230, irregularity 250 is formed at their interface also in the present mode. In addition to that, irregularity 260 is formed also at the interface between the intermediate layer 230 and the outermost layer 240. Thereby, a contact area of the intermediate layer 230 and the outermost layer 240 may be increased and the adhesion may be improved by causing mutual diffusion of the both.

The adhesion of the respective interface may be enhanced by forming the irregularity 250 at the interface between the under layer 220 and the intermediate layer 230 and also at the interface between the intermediate layer 230 and the outermost layer 240 in the switch 200 of the third mode shown in FIG. 7.

(Third Mode of Manufacturing Method of Silver-Coated Composite Material for Movable Contact)

A third mode of the manufacturing method of the silver-coated composite material for movable contact for manufacturing the silver-coated composite material for movable contact 100A of the second mode shown in FIG. 6 will be explained below with reference to the flowchart shown in FIG. 2. While its specific example is almost the same with the first mode of the manufacturing method of the silver-coated composite material for movable contact described above, there is a difference in the stage of forming the under layer 120.

In the manufacturing method of the third mode, as a first step, a stainless strip that becomes the base material 110 is cathode electrolytic-degreased within an alkaline solution such as orthosilicate soda or caustic soda and is then pickled by hydrochloric acid to activate (S1 in FIG. 2).

In the next second step, the under layer 120 is formed by plating nickel by electrolyzing with an electrolytic solution containing nickel chloride and free hydrochloric acid with 2 to 5 A/dm² of cathode current density (S2 in FIG. 2). Here, it is possible to plate nickel having the irregularity 150 on the surface of the base material 110 as the under layer 120 by controlling current density of electric current flowing through the base material 110 for example. Besides that, it is possible to plate nickel having the irregularity 150 on the surface of the base material 110 even by such a method of controlling a flow of plating solution for example. Reproducibility is enhanced when the maximum thickness of the under layer 120 is less than 0.04 μm by any means. A value of the surface roughness (maximum roughness: Rmax) of the under layer 120 in this case is smaller than a value of maximum thickness of an underlying region 120. It is noted that as the electrolytic solution of the nickel plating described above, an electrolytic solution to which nickel sulfamate (100 to 150 g/liter) and boron (20 to 50 g/liter) are added and whose pH is modified within a range from 2.5 to 4.5 may be used.

In the next third step, the intermediate layer 130 is formed by plating copper by electrolyzing with an electrolytic solution containing copper sulfate and free sulfuric acid with 5 A/dm² of cathode current density (S3 in FIG. 2).

In the final fourth step, the outermost layer 140 is formed by plating silver by electrolyzing with an electrolytic solution containing silver cyanide and potassium cyanide with 2 to 15 A/dm² of cathode current density (S4 in FIG. 2). Thus, the silver-coated composite material for movable contact 100A may be manufactured through the process from the first step S1 to the fourth step S4.

It is noted that the same modified example with that of the first mode of the manufacturing method is applicable in the process of forming the under layer 120, the intermediate layer 130 and the outermost layer 140.

(First Embodiment of Manufacturing Method of Third Mode)

The silver-coated composite material for movable contact 100A and a manufacturing method thereof of the above-mentioned mode will be explained in detail further by using an embodiment.

In the embodiment described below, a strip shape stainless steel SUS301 (referred to as the SUS301 strip hereinafter) is used as the base material 110. The dimension of the SUS301 strip is 0.06 mm thick and 100 mm strip width. In the plating line that continuously threads and winds up the SUS301 strip, the first step of electrolytic-degreasing, pickling and electrolytic-activating the SUS301 strip, the second step of implementing the nickel plating (or nickel-cobalt plating) and washing, the third step of implementing the copper plating and washing and the fourth step of the silver strike plating, silver plating, washing and drying are respectively carried out in the same manner with the manufacturing method of the first mode.

The followings are the processing conditions of the respective steps.

1. First Step (Electrolytic Degreasing, Electrolytic Activation):

The same with the manufacturing method of the first mode.

2. Second Step:

### (1) In Case of Nickel Plating:

Plating is implemented by electrolyzing with an electrolytic solution containing 10 to 50 g of nickel chloride hexahydrate (25 g/liter in the present embodiment) and 30 to 100 g of free hydrochloric acid (50 g/liter in the present embodiment) with 2 to 5 A/dm² of cathode current density (3 A/dm² in the present embodiment). The cathode current density and the flow of the plating solution are appropriately changed so that the irregularity 150 is formed in the under layer 120.

### (2) In Case of Nickel Alloy Plating:

Plating is implemented by adding cobalt chloride hexahydrate or secondary copper chloride dehydrate into the plating solution described above so that cobalt ion concentration or copper ion concentration within the plating solution corresponds to 5 to 20% of concentration (10% in the present embodiment) in which nickel ion and cobalt ion or copper ion are added.

3. Third Step:

The same with the manufacturing method of the first mode.

4. Fourth Step:

The same with the manufacturing method of the first mode.

Table 4 shows samples of the present embodiment in which thicknesses of the under layer 120, the intermediate layer 130 and the outermost layer 140 are changed variously. Here, a difference of irregularity (%) is represented by a value obtained by dividing a difference between a maximum value and minimum value of the thickness of the under layer 120 by an average value (arithmetic average value measured at arbitrarily selected ten points) of the thickness of the under layer 120 and the current density of the electric current flowing through the base material 110 is controlled in the second step. The value of the difference of irregularity is included in Table 4.

It is noted that heat treatment of two hours at 250° C. within argon (Ar) gas atmosphere was carried out on the sample Nos. 49A through 52A of the embodiment shown in Table 4.

A switch 200 having the structure shown in FIGS. 3 and 4 was made by using the silver-coated composite material for movable contacts in Table 4 manufactured under the processing conditions described above. The structure of the switch and the evaluation method of the silver-coated composite material for movable contact are the same with the first mode of the silver-coated composite material for movable contact described above.

A keying test was carried out by repeating the On/Off states shown in FIGS. 4A and 4B by using the switch 200 constructed as described above under the same conditions with the conditions described in the first mode of the silver-coated composite material for movable contact described above. Table 5 shows measured results of temporal changes of contact resistance during the keying test of the domed movable contact 210, representing initial values, after keying by 1 million times (After Keying 1) and after keying by 2 million times (After Keying 2), respectively. It was also observed whether or not the domed movable contact 210 generated cracks after finishing the keying test of 2 million times and Table 5 also shows its results. It is noted that the value of the contact resistance is considered to be practically permissible if it is less than 100 mΩ.

A heating test was carried out on all of the samples by heating for 1,000 hours in air bath at 85° C. Changes of the contact resistance were measured and Table 5 shows its results.

TABLE 4

| | | OUTERMOST | | INTERMEDIATE | | UNDER LAYER | | | INTERMEDIATE + |
|---|---|---|---|---|---|---|---|---|---|
| | | LAYER | | LAYER | | | | IRREGULARITY | UNDER |
| | SAMPLE | | AVERAGE | | AVERAGE | | AVERAGE | DIFFERENCE | TOTAL AVERAGE |
| | No. | SPECIES | THICK (μm) | SPECIES | THICK (μm) | SPECIES | THICK (μm) | (%) | THICK (μm) |
| EMBODIMENT | 1A | Ag | 1.0 | Cu | 0.15 | Ni | 0.040 | 30 | 0.190 |
| | 2A | Ag | 1.0 | Cu | 0.10 | Ni | 0.040 | 30 | 0.140 |
| | 3A | Ag | 1.0 | Cu | 0.04 | Ni | 0.040 | 30 | 0.080 |
| | 4A | Ag | 1.0 | Cu | 0.02 | Ni | 0.040 | 30 | 0.060 |
| | 5A | Ag | 1.0 | Cu | 0.15 | Ni | 0.020 | 30 | 0.170 |
| | 6A | Ag | 1.0 | Cu | 0.10 | Ni | 0.020 | 30 | 0.120 |
| | 7A | Ag | 1.0 | Cu | 0.04 | Ni | 0.020 | 30 | 0.060 |
| | 8A | Ag | 1.0 | Cu | 0.02 | Ni | 0.020 | 30 | 0.040 |
| | 9A | Ag | 1.0 | Cu | 0.15 | Ni | 0.012 | 30 | 0.162 |
| | 10A | Ag | 1.0 | Cu | 0.10 | Ni | 0.012 | 30 | 0.112 |
| | 11A | Ag | 1.0 | Cu | 0.04 | Ni | 0.012 | 30 | 0.052 |
| | 12A | Ag | 1.0 | Cu | 0.02 | Ni | 0.012 | 30 | 0.032 |
| | 13A | Ag | 1.0 | Cu | 0.15 | Ni | 0.009 | 30 | 0.159 |
| | 14A | Ag | 1.0 | Cu | 0.10 | Ni | 0.009 | 30 | 0.109 |
| | 15A | Ag | 1.0 | Cu | 0.04 | Ni | 0.009 | 30 | 0.049 |
| | 16A | Ag | 1.0 | Cu | 0.02 | Ni | 0.009 | 30 | 0.029 |
| | 17A | Ag | 1.0 | Cu | 0.15 | Ni | 0.005 | 30 | 0.155 |
| | 18A | Ag | 1.0 | Cu | 0.10 | Ni | 0.005 | 30 | 0.105 |
| | 19A | Ag | 1.0 | Cu | 0.04 | Ni | 0.005 | 30 | 0.045 |
| | 20A | Ag | 1.0 | Cu | 0.02 | Ni | 0.005 | 30 | 0.025 |
| | 21A | Ag | 1.0 | Cu | 0.15 | Ni | 0.001 | 30 | 0.151 |
| | 22A | Ag | 1.0 | Cu | 0.10 | Ni | 0.001 | 30 | 0.101 |
| | 23A | Ag | 1.0 | Cu | 0.04 | Ni | 0.001 | 30 | 0.041 |
| | 24A | Ag | 1.0 | Cu | 0.03 | Ni | 0.001 | 30 | 0.031 |
| | 25A | Ag | 0.5 | Cu | 0.10 | Ni | 0.040 | 30 | 0.140 |
| | 26A | Ag | 0.5 | Cu | 0.04 | Ni | 0.040 | 30 | 0.080 |
| | 27A | Ag | 0.5 | Cu | 0.10 | Ni | 0.020 | 30 | 0.120 |
| | 28A | Ag | 0.5 | Cu | 0.04 | Ni | 0.020 | 30 | 0.060 |
| | 29A | Ag | 0.5 | Cu | 0.10 | Ni | 0.012 | 30 | 0.112 |
| | 30A | Ag | 0.5 | Cu | 0.04 | Ni | 0.012 | 30 | 0.052 |
| | 31A | Ag | 0.5 | Cu | 0.10 | Ni | 0.009 | 30 | 0.109 |
| | 32A | Ag | 0.5 | Cu | 0.04 | Ni | 0.009 | 30 | 0.049 |
| | 33A | Ag | 0.5 | Cu | 0.10 | Ni | 0.005 | 30 | 0.105 |
| | 34A | Ag | 0.5 | Cu | 0.04 | Ni | 0.005 | 30 | 0.045 |
| | 35A | Ag | 0.5 | Cu | 0.10 | Ni | 0.001 | 30 | 0.101 |
| | 36A | Ag | 0.5 | Cu | 0.04 | Ni | 0.001 | 30 | 0.041 |
| | 37A | Ag | 1.5 | Cu | 0.10 | Ni | 0.040 | 30 | 0.140 |
| | 38A | Ag | 1.5 | Cu | 0.04 | Ni | 0.040 | 30 | 0.080 |
| | 39A | Ag | 1.5 | Cu | 0.10 | Ni | 0.020 | 30 | 0.120 |
| | 40A | Ag | 1.5 | Cu | 0.04 | Ni | 0.020 | 30 | 0.060 |
| | 41A | Ag | 1.5 | Cu | 0.10 | Ni | 0.012 | 30 | 0.112 |
| | 42A | Ag | 1.5 | Cu | 0.04 | Ni | 0.012 | 30 | 0.052 |
| | 43A | Ag | 1.5 | Cu | 0.10 | Ni | 0.009 | 30 | 0.109 |
| | 44A | Ag | 1.5 | Cu | 0.04 | Ni | 0.009 | 30 | 0.049 |
| | 45A | Ag | 1.5 | Cu | 0.10 | Ni | 0.005 | 30 | 0.105 |
| | 46A | Ag | 1.5 | Cu | 0.04 | Ni | 0.005 | 30 | 0.045 |
| | 47A | Ag | 1.5 | Cu | 0.10 | Ni | 0.001 | 30 | 0.101 |
| | 48A | Ag | 1.5 | Cu | 0.04 | Ni | 0.001 | 30 | 0.041 |
| | 49A | Ag | 1.0 | Cu | 0.10 | Ni | 0.040 | 30 | 0.140 |
| | 50A | Ag | 1.0 | Cu | 0.10 | Ni | 0.009 | 30 | 0.109 |
| | 51A | Ag | 1.0 | Cu | 0.04 | Ni | 0.040 | 30 | 0.080 |
| | 52A | Ag | 1.0 | Cu | 0.04 | Ni | 0.009 | 30 | 0.049 |
| COMPARATIVE | 101A | Ag | 1.0 | Cu | 0.01 | Ni | 0.009 | 0 | 0.019 |
| EXAMPLE | 102A | Ag | 1.0 | Cu | 0.10 | Ni | 0.050 | 0 | 0.150 |
| | 103A | Ag | 1.0 | Cu | 0.30 | Ni | 0.050 | 0 | 0.350 |
| | 104A | Ag | 1.0 | Cu | 0.10 | Ni | 0.100 | 0 | 0.200 |
| | 105A | Ag | 1.0 | Cu | 0.30 | Ni | 0.100 | 0 | 0.400 |
| | 106A | Ag | 1.0 | Cu | 0.01 | Ni | 0.300 | 0 | 0.310 |
| | 107A | Ag | 1.0 | Cu | 0.10 | Ni | 0.300 | 0 | 0.400 |
| | 108A | Ag | 1.0 | Cu | 0.30 | Ni | 0.300 | 0 | 0.600 |

TABLE 5

| | | | | | | | | APPEARANCE AFTER | |
|---|---|---|---|---|---|---|---|---|---|
| | | | | CONTACT RESISTANCE (mΩ) | | | | KEYING 2 | |
| | SAMPLE | TREATED | PROC- | INITIAL | AFTER | AFTER | HEATING | UNDERLAYER | |
| | No. | BY HEAT? | ESSABILITY | VALUE | KEYING 1 | KEYING 2 | TEST | EXPOSED? | CRACK |
| EMBODIMENT | 1A | none | ◯ | 11 | 14 | 35 | 84 | none | none |
| | 2A | none | ◯ | 12 | 14 | 32 | 70 | none | none |
| | 3A | none | ◯ | 12 | 14 | 27 | 58 | none | none |
| | 4A | none | ◯ | 12 | 14 | 25 | 52 | none | none |
| | 5A | none | ◯ | 10 | 13 | 33 | 87 | none | none |
| | 6A | none | ◯ | 10 | 13 | 29 | 71 | none | none |
| | 7A | none | ◯ | 10 | 13 | 25 | 60 | none | none |
| | 8A | none | ◯ | 11 | 13 | 23 | 54 | none | none |
| | 9A | none | ◯ | 10 | 13 | 31 | 89 | none | none |
| | 10A | none | ◯ | 10 | 13 | 27 | 77 | none | none |
| | 11A | none | ◯ | 11 | 13 | 24 | 63 | none | none |
| | 12A | none | ◯ | 11 | 14 | 23 | 55 | none | none |
| | 13A | none | ⊚ | 10 | 13 | 29 | 89 | none | none |
| | 14A | none | ⊚ | 10 | 13 | 26 | 74 | none | none |
| | 15A | none | ⊚ | 11 | 13 | 22 | 60 | none | none |
| | 16A | none | ⊚ | 11 | 14 | 22 | 53 | none | none |
| | 17A | none | ⊚ | 10 | 13 | 29 | 88 | none | none |
| | 18A | none | ⊚ | 10 | 13 | 26 | 74 | none | none |
| | 19A | none | ⊚ | 10 | 13 | 21 | 58 | none | none |
| | 20A | none | ⊚ | 10 | 13 | 21 | 52 | none | none |
| | 21A | none | ⊚ | 9 | 12 | 30 | 90 | none | none |
| | 22A | none | ⊚ | 10 | 13 | 26 | 74 | none | none |
| | 23A | none | ⊚ | 10 | 13 | 22 | 60 | none | none |
| | 24A | none | ⊚ | 10 | 13 | 22 | 54 | none | none |
| | 25A | none | ◯ | 13 | 17 | 39 | 73 | none | none |
| | 26A | none | ◯ | 13 | 17 | 36 | 61 | none | none |
| | 27A | none | ◯ | 13 | 16 | 39 | 74 | none | none |
| | 28A | none | ◯ | 13 | 16 | 35 | 62 | none | none |
| | 29A | none | ◯ | 12 | 16 | 37 | 75 | none | none |
| | 30A | none | ◯ | 12 | 16 | 34 | 63 | none | none |
| | 31A | none | ⊚ | 12 | 16 | 34 | 75 | none | none |
| | 32A | none | ⊚ | 12 | 15 | 32 | 62 | none | none |
| | 33A | none | ⊚ | 12 | 15 | 34 | 75 | none | none |
| | 34A | none | ⊚ | 12 | 15 | 32 | 62 | none | none |
| | 35A | none | ⊚ | 12 | 15 | 34 | 76 | none | none |
| | 36A | none | ⊚ | 12 | 15 | 32 | 63 | none | none |
| | 37A | none | ◯ | 10 | 13 | 32 | 68 | none | none |
| | 38A | none | ◯ | 10 | 13 | 30 | 58 | none | none |
| | 39A | none | ◯ | 10 | 13 | 32 | 67 | none | none |
| | 40A | none | ◯ | 10 | 13 | 29 | 57 | none | none |
| | 41A | none | ◯ | 10 | 13 | 31 | 66 | none | none |
| | 42A | none | ◯ | 10 | 13 | 29 | 55 | none | none |
| | 43A | none | ⊚ | 10 | 13 | 19 | 68 | none | none |
| | 44A | none | ⊚ | 10 | 13 | 18 | 60 | none | none |
| | 45A | none | ⊚ | 9 | 12 | 18 | 67 | none | none |
| | 46A | none | ⊚ | 9 | 12 | 18 | 59 | none | none |
| | 47A | none | ⊚ | 9 | 12 | 19 | 68 | none | none |
| | 48A | none | ⊚ | 9 | 12 | 19 | 60 | none | none |
| | 49A | yes | ◯ | 14 | 16 | 28 | 45 | none | none |
| | 50A | yes | ⊚ | 14 | 16 | 27 | 44 | none | none |
| | 51A | yes | ◯ | 13 | 15 | 25 | 34 | none | none |
| | 52A | yes | ⊚ | 13 | 15 | 24 | 33 | none | none |
| COMPARATIVE | 101A | none | X | 15 | 50 | 560 | 60 | none | yes |
| EXAMPLE | 102A | none | Δ | 12 | 18 | 125 | 75 | none | yes |
| | 103A | none | Δ | 13 | 35 | 330 | 820 | none | yes |
| | 104A | none | X | 14 | 20 | 145 | 72 | none | yes |
| | 105A | none | X | 15 | 44 | 420 | 760 | yes | yes |
| | 106A | none | X | 16 | 36 | 510 | 125 | yes | yes |
| | 107A | none | X | 16 | 30 | 170 | 162 | yes | yes |
| | 108A | none | X | 17 | 61 | 750 | 1250 | yes | yes |

The increase of the contact resistance of all of the sample Nos. 1A through 52A of the embodiment shown in Table 4 was small even after the keying test of 2 million times and no exposure of the under layer 120 and the intermediate layer 130 was seen in the contact point after keying 2 million times as shown in Table 5. Still more, the increase of the contact resistance was small even after heating for 1,000 hours and the value of the contact resistance of the all samples was less than 100 mΩ, which is practically no problem.

However, the sample No. 101A of a comparative example in which a total thickness of the under layer 120 and the intermediate layer 130 is less than 0.025 μm deteriorates its workability due to the drop of the adhesion of the respective layers and the sample Nos. 102A through 108A in which the thickness of the under layer 120 exceeds the upper limit of the range of the invention (0.05 μm or more) have a tendency to deteriorate their workability. Still more, an increase of the contact resistance considered to be caused by deteriorated workability (specifically, the state in which the value of the contact resistance exceeds 100 mΩ) is detected in the sample Nos. 101A through 108A of the comparative examples after keying by 2 million times.

Still more, crack which is considered to be caused by inferior workability was found in the contact part of the sample Nos. 101A through 108A of the comparative example and the outermost layer of the contact part peeled and the under layer was exposed in the sample Nos. 106A through 108A whose under layer 120 is 0.3 μm thick.

Meanwhile, the contact resistance remarkably increased (to the state in which the value of the contact resistance exceeds 100 mΩ in concrete) after the heating test and cracks were seen after the keying test in the sample Nos. 103A, 105A and 108A whose intermediate layer 120 is 0.3 μm thick.

(Second Embodiment of Manufacturing Method of Third Mode)

Here, a second embodiment of the manufacturing method of the third mode for manufacturing the silver-coated composite material for movable contact 100A will be explained. About the under layer 120: When nickel alloy plating in which 10 mass % of nickel is replaced with copper or cobalt was used and tested in the same manner with the sample Nos. 1A through 52A and sample Nos. 101A through 108A in Table 4, the test result was substantially the same with the results shown in Table 5. The same also applies to a case when nickel is completely replaced with cobalt.

About the intermediate layer 130: When copper alloy plating in which 0.5 mass % of copper is replaced with tin or zinc was used and tested in the same manner with the sample Nos. 1A through 52A and sample Nos. 101A through 108A in Table 4, the test result was substantially the same with the results shown in Table 5.

About the outermost layer 140: When silver alloy plating in which 1 mass % of silver is replaced with antimony was used and tested in the same manner with the sample Nos. 1A through 52A and sample Nos. 101A through 108A in Table 4, the test result was substantially the same with the results shown in Table 5.

Still more, when the respective samples in the embodiment shown in Table 4 were appropriately combined, the test results were substantially the same with the results shown in Table 5.

(Fourth Mode of Manufacturing Method of Silver-Coated Composite Material for Movable Contact)

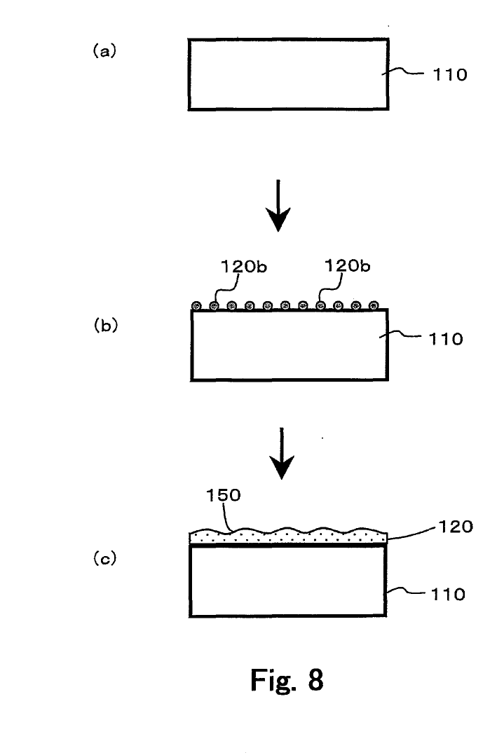

Next, a fourth mode of the manufacturing method for manufacturing the silver-coated composite material for movable contact 100A shown in FIG. 6 will be explained with reference to FIGS. 8A through 8C. It is noted that it is needless to say that this manufacturing method may be applied to the method for manufacturing the switch 200 shown in FIG. 7.

The manufacturing method of the silver-coated composite material for movable contact of the present mode has the following steps.

(First Step) The base material (base material of the metal strip) 110 which is a stainless strip composed of an alloy whose main component is iron or nickel is electrolytic-degreased and then activated by pickling by an acid solution containing nickel ion to form the under layer 120 which is composed of nickel and which has the irregularity 150 on its surface on the base material 110.

The activation process for activating the base material 110 is carried out under the following conditions for example in this first step.

(1) As the acid solution containing nickel ion, an acid solution to which 120 g/liter of free hydrochloric acid and 12 g/liter of nickel chloride hexahydrate are added is used. It is noted that as the acid solution containing nickel ion, it is preferable to add free hydrochloric acid in a range of 80 to 200 g/liter (or more preferably 100 to 150 g/liter) and nickel chloride hexahydrate in a range of 5 to 20 g/liter (or more preferably 10 to 15 g/liter). When the additive amounts of free hydrochloric acid and nickel chloride hexahydrate are out of those ranges, the adhesion between the base material and the under layer tends to drop in all of the cases.

(2) The cathode current density during the activation process is set at 3.0 (A/dm²). It is noted that the cathode current density during the activation process is preferable to be in a range of 2.0 to 5.0 (A/dm²) and is more preferable to be in a range of 2.5 to 4.0 (A/dm²) from the aspect of effectively forming the irregularity on the under layer. When the cathode current density during the activation process is less than 2.0 (A/dm²), it is not preferable because the adhesion between the base material and the under layer tends to drop. Still more, when the cathode current density during the activation process is higher than 5.0 (A/dm²), it is also not so preferable because there is a case when an influence of generated heat of the base material is brought out when the base material is stainless steel.

By carrying out the activation process of the base material 110 shown in FIG. 8A under such conditions, nucleuses 120b of nickel (Ni) are formed with certain intervals on the whole surface of the base material 110 (see FIG. 8B) and the under layer 120 having the irregularity 150 on the surface thereof is formed on the whole surface of the base material 110 (see FIG. 8C). It is noted that while the under layer 120 composed of nickel is formed by the activation process in the present mode, the activation process of the base material 110 is carried out by an acid solution containing cobalt ion in the first step described above in forming the under layer composed of cobalt by the similar activation process.

(Second Step) The intermediate layer 130 is formed on the under layer 120 by plating copper by electrolyzing with an electrolytic solution containing copper sulfate and free sulfuric acid with 5 A/dm² of cathode current density.

(Third Step) The outermost layer 140 is formed on the intermediate layer 130 by plating silver by electrolyzing with an electrolytic solution containing silver cyanide and potassium cyanide.

Thus, the under layer 120 having the irregularity 150 on the surface thereof is formed on the base material 110 during the activation process of activating by pickling the base material 110 with the acid solution containing nickel ion after electrolytic-degreasing it in the manufacturing method of the silver-coated composite material for movable contact of the present mode. Therefore, it becomes unnecessary to carry out the step of nickel plating or nickel alloy plating for forming the under layer 120 (S2 in FIG. 2) in the manufacturing method of the silver-coated composite material for movable contact of the third mode described above by using FIG. 2. Accordingly, the manufacturing step is simplified and operation time may be shortened, so that the silver-coated composite material for movable contact may be manufactured at low cost.

Still more, the under layer 120 having the irregularity 150 on the surface thereof may be formed on the base material 110 during the activation process of the base material 110 composed of stainless steel. Forming the under layer 120 as described above allows not only the adhesion between the base material 110 and the under layer 120 to be improved, but also the adhesion between the under layer 120 and the intermediate layer 130 to be improved and the long-life silver-coated composite material for movable contact to be obtained.

As samples manufactured by the manufacturing method of the fourth mode described above, samples in which thicknesses of the under layer 120, the intermediate layer 130 and the outermost layer 140 are changed variously in the same manner with the samples of the embodiment respectively shown in Table 4 were prepared and represented as sample Nos. 201A through 252A (see Table 6). It is noted that heat treatment of two hours at 250° C. within argon (Ar) gas atmosphere was carried out on the sample Nos. 249A through 252A of the embodiment shown in Table 6. Still more, sample Nos. 301A through 308A (see Table 6) were prepared as comparative examples. It is noted that the sample Nos. 201A through 252A in Table 6 are samples respectively having the same layer structure with the sample Nos. 1A through 52A in Table 4 and the sample Nos. 301A through 308A of the comparative examples shown in Table 6 are samples respectively having the same layer structure with those of the sample Nos. 101A through 108A of the comparative examples shown in Table 4. Their correspondence relationship is made such that the sample No. of the embodiment shown in Table 4 added with 200 is the sample No. of the embodiment shown in Table 6.

A switch similar to the switch 200 having the structure as shown in FIGS. 3 and 4 was made by using the silver-coated composite material for movable contacts of the sample Nos. 201A through 252A manufactured under the processing conditions described above and the sample Nos. 301A through 308A. The other conditions were the same with those of the case when the silver-coated composite material for movable contacts of the sample Nos. 1A through 52A and the sample Nos. 101A through 108A described above were used.

The keying test was carried out by repeating the On/Off states shown in FIGS. 4A and 4B by using the switch constructed as described above. During the keying test, keying of 2 million times in maximum is carried out with 9.8 N/mm² of contact pressure and 5 Hz of keying speed. Table 6 shows measured results of temporal changes of contact resistance during the keying test of the domed movable contact 210, representing initial values, after keying by 1 million times (After Keying 1) and after keying by 2 million times (After Keying 2), respectively. It was also observed whether or not the domed movable contact 210 generated cracks after finishing the keying test of 2 million times and Table 6 also shows its results.

A heating test was carried out on all of the samples by heating for 1,000 hours in air bath at 85° C. Changes of the contact resistance were measured and Table 6 shows its result.

TABLE 6

| | | | | | | | | APPEARANCE AFTER | |
|---|---|---|---|---|---|---|---|---|---|
| | | | | CONTACT RESISTANCE (mΩ) | | | | KEYING 2 | |
| | SAMPLE | TREATED | PROC- | INITIAL | AFTER | AFTER | HEATING | UNDERLAYER | |
| | No. | BY HEAT? | ESSABILITY | VALUE | KEYING 1 | KEYING 2 | TEST | EXPOSED? | CRACK |
| EMBODIMENT | 201A | none | ◯ | 11 | 12 | 16 | 17 | none | none |
| | 202A | none | ◯ | 12 | 12 | 16 | 15 | none | none |
| | 203A | none | ◯ | 12 | 12 | 16 | 15 | none | none |
| | 204A | none | ◯ | 12 | 12 | 16 | 15 | none | none |
| | 205A | none | ◯ | 10 | 11 | 16 | 14 | none | none |
| | 206A | none | ◯ | 10 | 11 | 16 | 14 | none | none |
| | 207A | none | ◯ | 10 | 11 | 15 | 14 | none | none |
| | 208A | none | ◯ | 11 | 11 | 16 | 15 | none | none |
| | 209A | none | ◯ | 10 | 11 | 16 | 15 | none | none |
| | 210A | none | ◯ | 10 | 11 | 16 | 14 | none | none |
| | 211A | none | ◯ | 11 | 11 | 16 | 14 | none | none |
| | 212A | none | ◯ | 11 | 12 | 17 | 15 | none | none |
| | 213A | none | ⊚ | 10 | 11 | 16 | 14 | none | none |
| | 214A | none | ⊚ | 10 | 11 | 16 | 14 | none | none |
| | 215A | none | ⊚ | 11 | 12 | 16 | 15 | none | none |
| | 216A | none | ⊚ | 11 | 12 | 15 | 15 | none | none |
| | 217A | none | ⊚ | 10 | 11 | 15 | 14 | none | none |
| | 218A | none | ⊚ | 10 | 11 | 15 | 14 | none | none |
| | 219A | none | ⊚ | 10 | 11 | 15 | 14 | none | none |
| | 220A | none | ⊚ | 10 | 11 | 15 | 14 | none | none |
| | 221A | none | ⊚ | 9 | 10 | 14 | 13 | none | none |
| | 222A | none | ⊚ | 10 | 10 | 14 | 14 | none | none |
| | 223A | none | ⊚ | 10 | 11 | 14 | 14 | none | none |
| | 224A | none | ⊚ | 10 | 11 | 14 | 14 | none | none |
| | 225A | none | ◯ | 13 | 15 | 20 | 25 | none | none |
| | 226A | none | ◯ | 13 | 15 | 20 | 23 | none | none |
| | 227A | none | ◯ | 13 | 15 | 20 | 25 | none | none |
| | 228A | none | ◯ | 13 | 15 | 20 | 23 | none | none |
| | 229A | none | ◯ | 12 | 14 | 20 | 24 | none | none |
| | 230A | none | ◯ | 12 | 14 | 19 | 23 | none | none |
| | 231A | none | ⊚ | 12 | 14 | 20 | 23 | none | none |
| | 232A | none | ⊚ | 12 | 14 | 19 | 22 | none | none |
| | 233A | none | ⊚ | 12 | 14 | 20 | 23 | none | none |
| | 234A | none | ⊚ | 12 | 14 | 19 | 21 | none | none |
| | 235A | none | ⊚ | 12 | 14 | 20 | 23 | none | none |
| | 236A | none | ⊚ | 12 | 14 | 19 | 21 | none | none |
| | 237A | none | ◯ | 10 | 11 | 13 | 13 | none | none |
| | 238A | none | ◯ | 10 | 11 | 13 | 13 | none | none |
| | 239A | none | ◯ | 10 | 11 | 12 | 13 | none | none |
| | 240A | none | ◯ | 10 | 11 | 12 | 13 | none | none |
| | 241A | none | ◯ | 10 | 10 | 12 | 12 | none | none |
| | 242A | none | ◯ | 10 | 10 | 12 | 13 | none | none |
| | 243A | none | ⊚ | 9 | 10 | 12 | 12 | none | none |
| | 244A | none | ⊚ | 9 | 10 | 11 | 13 | none | none |
| | 245A | none | ⊚ | 9 | 10 | 11 | 12 | none | none |
| | 246A | none | ⊚ | 9 | 10 | 11 | 13 | none | none |
| | 247A | none | ⊚ | 9 | 9 | 11 | 12 | none | none |
| | 248A | none | ⊚ | 9 | 9 | 10 | 13 | none | none |
| | 249A | yes | ◯ | 14 | 15 | 18 | 17 | none | none |
| | 250A | yes | ⊚ | 14 | 14 | 17 | 16 | none | none |
| | 251A | yes | ◯ | 13 | 14 | 16 | 16 | none | none |
| | 252A | yes | ⊚ | 13 | 14 | 16 | 16 | none | none |
| COMPARATIVE | 301A | none | X | 15 | 45 | 380 | 52 | none | yes |
| EXAMPLE | 302A | none | Δ | 12 | 18 | 110 | 67 | none | yes |
| | 303A | none | Δ | 13 | 33 | 280 | 660 | none | yes |
| | 304A | none | X | 14 | 20 | 130 | 66 | none | yes |
| | 305A | none | X | 15 | 42 | 360 | 620 | yes | yes |
| | 306A | none | X | 16 | 35 | 440 | 103 | yes | yes |
| | 307A | none | X | 16 | 29 | 130 | 142 | yes | yes |
| | 308A | none | X | 17 | 58 | 610 | 1010 | yes | yes |

The increase of the contact resistance of all of the sample Nos. 201A through 252A of the embodiment shown in Table 6 was small even after the keying test of 2 million times and no exposure of the under layer 120 and the intermediate layer 130 was seen in the contact point after keying 2 million times. Still more, the increase of the contact resistance was small even after heating for 1,000 hours. Specifically, it was found that the increase of the contact resistance after the keying test of 2 million times and the increase of the contact resistance after heating for 1,000 hours of the sample Nos. 201A through 252A shown in Table 6 were small as compared to those of the sample Nos. 1A through 52A of the embodiment shown in Table 4, that the value of the contact resistance of all of the samples in Table 6 is less than 30 mΩ and that the performance as a material of the contact is very excellent. It is noted that the various modifications explained in the first and second embodiments of the manufacturing method of the third mode are applicable to the manufacturing method of the fourth mode described above.

(Fourth Mode of Silver-Coated Composite Material for Movable Contact)

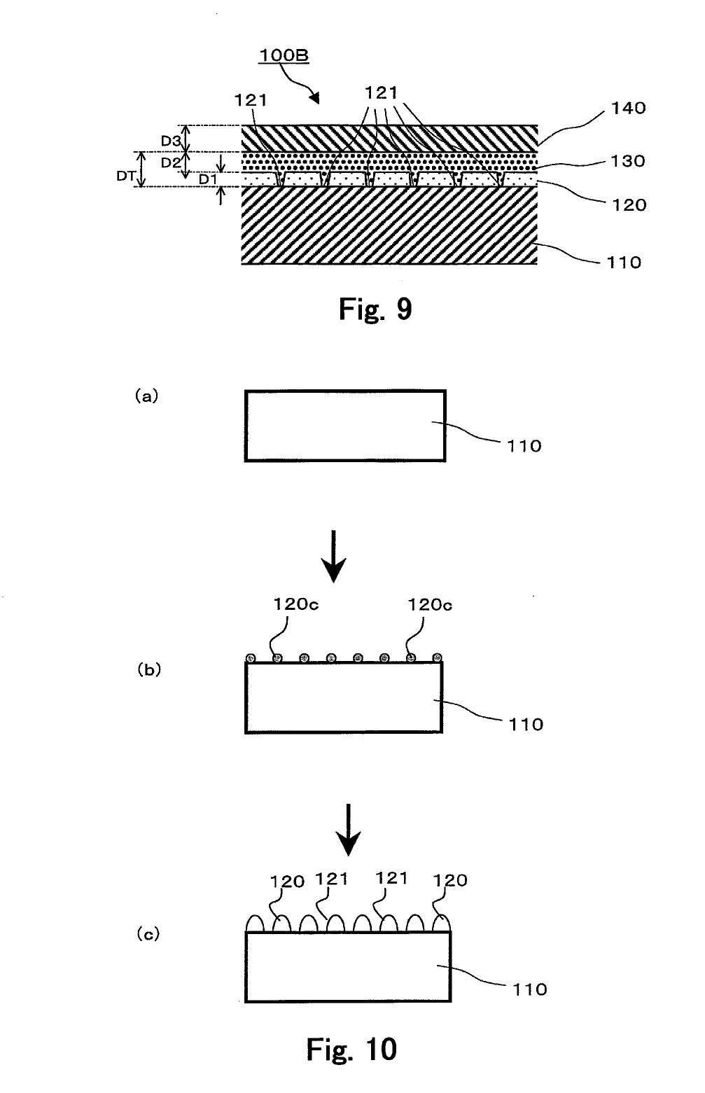

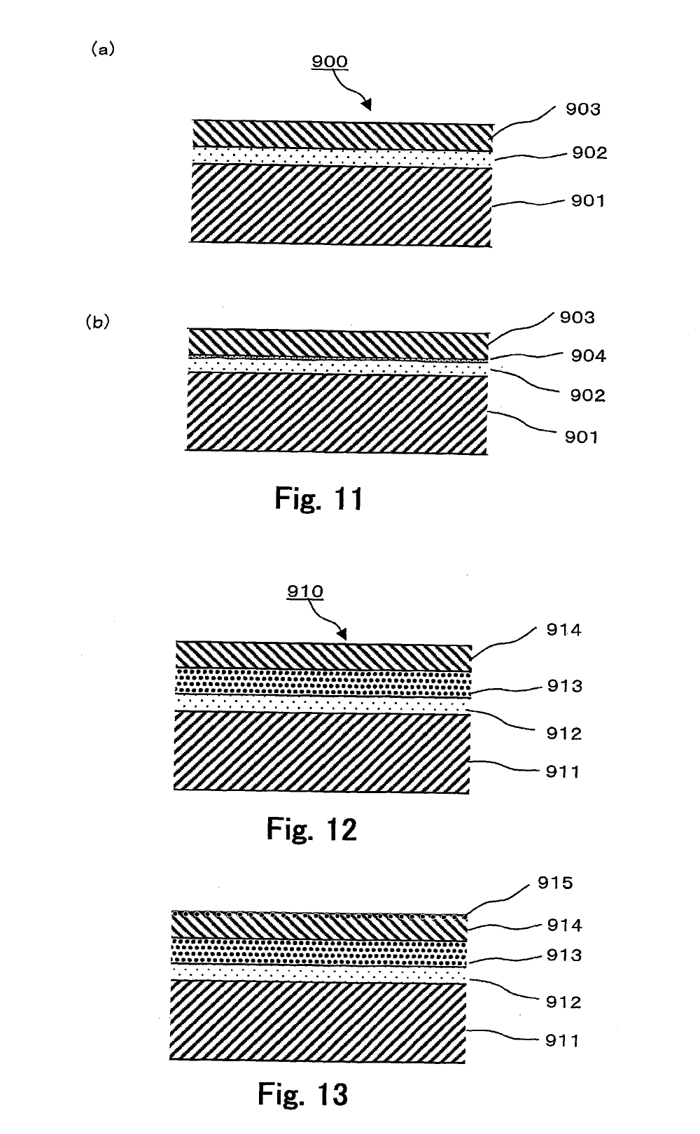

A fourth mode of the silver-coated composite material for movable contact of the invention will be explained by using a section view shown in FIG. 9. The silver-coated composite material for movable contact 100B of the present mode includes a base material 110 composed of an alloy whose main component is iron or nickel, an underlying region 120 formed as an under layer the surface of the base material 110, an intermediate layer 130 formed on the underlying region 120 and an outermost layer 140 formed on the intermediate layer 130. Since the present mode has parts in common with the first mode of the silver-coated composite material for movable contact described above, the present mode will be explained centering on their differences.

While nickel, cobalt or an alloy whose main component is nickel or cobalt (the whole mass ratio is 50 mass % or more) is used as metal forming the underlying region 120, it is preferable to use nickel among them. The underlying region 120 may be formed by electrolysis by setting the base material 110 composed of stainless steel at the cathode and by using electrolytic solution containing nickel chloride and free hydrochloric acid for example. The average value of the thickness of the underlying region 120 is preferable to be 0.001 to 0.04 μm. The more preferable thickness is 0.001 to 0.009 μm. It is noted that the case of using nickel as the metal of the underlying region 120 will be explained below, the same effect with the following explanation will be obtained even if anyone of cobalt, nickel alloy and cobalt alloy is used instead of nickel.

In order to enhance the adhesion between the underlying region 120 and the intermediate layer 130, underlying missing portions (missing portions) 121 are formed at part of the under layer 120 so that the intermediate layer 130 contacts directly with the base material 110 through the underlying missing portions 121 in the present mode. A contact area of the underlying region 120 and the intermediate layer 130 may be increased by providing the underlying missing portions 121 and the adhesion may be improved by causing mutual diffusion of the both. The interface of the underlying region 120 and the intermediate layer 130 is formed to have the wavy irregularity in the silver-coated composite material for movable contact 100B shown in FIG. 9 so that the intermediate layer 130 contacts directly with the surface of the base material 110 through the underlying missing portions 121.

Still more, in order to suppress the increase of the contact resistance, the preferable thickness of the intermediate layer 130 is determined so that the copper in the intermediate layer 130 does not reach the surface of the outermost layer 140 within the range in which the interlayer adhesions between the surface of the base material 110 and the underlying region 120, between the underlying region 120 and the intermediate layer 130 and the intermediate layer 130 and the outermost layer 140 in the present mode. Still more, an average total thickness DT in which the average thickness D2 of the intermediate layer 130 is added to the average thickness D1 of the underlying region 120 is set so as to fall within a range of 0.025 to 0.20 μm in the present mode.

Thereby, it becomes possible to suppress the diffusion of copper to the surface of the outermost layer 140 and the oxidation otherwise caused by that while maintaining the high interlayer adhesion. The most desirable form as the outermost layer is a structure in which it contains copper only in the vicinity of the intermediate layer and contains a silver or silver alloy layer containing no copper formed around the surface thereof. The thickness D3 of the outermost layer is preferable to be in a range from 0.5 to 1.5 μm.

Although it is preferable to thin the underlying region 120 and the intermediate layer 130 from the aspect of improving the workability, the lower limit value of 0.025 μm is set as the total thickness DT of the average thicknesses of the underlying region 120 and the intermediate layer 130 because the effect of enhancing the interlayer adhesions between the surface of the base material 110 and the underlying region 120, between the underlying region 120 and the intermediate layer 130 and between the intermediate layer 130 and the outermost layer 140 drops if the thickness falls below this value. Still more, the upper limit value of 0.20 μm is set for the total thickness DT of the average thickness of the underlying region 120 and the average thickness of the intermediate layer 130 because the increase of the contact resistance is prone to occur depending on use environment if the thickness exceeds that value. It is possible to prevent each layer from cracking during pressing by setting the average thickness D1 of the underlying region 120 and the average thickness D2 of the intermediate layer 130 within the range described above.

Each layer of the underlying region 120, the intermediate layer 130 and the outermost layer 140 of the silver-coated composite material for movable contact 100B of the present mode may be formed by using an arbitrary method such as electro-plating, nonelectrolytic plating, physical and chemical evaporation and others. Specifically, the present mode may be carried out in the same manner with the first mode of the silver-coated composite material for movable contact described above. It is noted that copper may be alloyed to the layers other than the intermediate layer 130 which is composed of copper or copper alloy. Specifically, it may be carried out in the same manner with the first mode of the silver-coated composite material for movable contact described above.

(Fifth Mode of Manufacturing Method of Silver-Coated Composite Material for Movable Contact)

A fifth mode of the manufacturing method of the silver-coated composite material for movable contact of the invention will be explained below with reference to the flowchart shown in FIG. 2. While its specific example is almost the same with that of the first and third modes of the manufacturing method of the silver-coated composite material for movable contact described above, there is a difference in the stage of forming the underlying region 120 (corresponds to the under layer 120 in the first and third modes of the manufacturing method).

In the manufacturing method of the fifth mode, as a first step, a stainless strip that becomes the base material 110 is cathode electrolytic-degreased within an alkaline solution such as orthosilicate soda or caustic soda and is then picked and activated by hydrochloric acid (S1 in FIG. 2).

In the next second step, the underlying region 120 is formed by plating nickel on part of the surface of the stainless strip that becomes the base material 110 by electrolyzing with an electrolytic solution containing nickel chloride and free hydrochloric acid with 2 to 5 A/dm² of cathode current density (S2 in FIG. 2). Here, it is possible to plate nickel only on part of the surface of the base material 110 by controlling current density of electric current flowing through the base material 110 for example. Besides that, it is possible to plate nickel only on part of the surface of the base material 110 even by such a method of controlling a flow of plating solution for example. Reproducibility is enhanced when the maximum thickness of the underlying region 120 is less than 0.04 μm by any means. A value of the surface roughness (maximum roughness: Rmax) of the underlying region 120 in this case is smaller than a value of maximum thickness of the underlying region 120. It is noted that as the electrolytic solution of the nickel plating described above, an electrolytic solution to which nickel sulfamate (100 to 150 g/liter) and boron (20 to 50 g/liter) are added and whose pH is modified within a range from 2.5 to 4.5 may be used.

In the next third step, the intermediate layer 130 is formed by plating copper by electrolyzing with an electrolytic solution containing copper sulfate and free sulfuric acid with 2 to 6 A/dm² of cathode current density (S3 in FIG. 2).

In the final fourth step, the outermost layer 140 is formed by plating silver by electrolyzing with an electrolytic solution containing silver cyanide and potassium cyanide with 2 to 15 A/dm² of cathode current density (S4 in FIG. 2). Thus, the silver-coated composite material for movable contact 100B may be manufactured through the process from the first step S1 to the fourth step S4.

It is noted that the same modified example with that of the first mode of the manufacturing method is applicable in the process of forming the underlying region 120, the intermediate layer 130 and the outermost layer 140. In this case, the under layer 120 is read to be the underlying region 120.

(First Embodiment of Manufacturing Method of Fifth Mode)

The fifth mode of the manufacturing method for manufacturing the silver-coated composite material for movable contact 100B of the fourth mode described above will be explained in detail further by using an embodiment.

In the embodiment described below, a strip shape stainless steel SUS301 (referred to as the SUS301 strip hereinafter) is used as the base material 110. The dimension of the SUS301 strip is 0.06 mm thick and 100 mm strip width. In the plating line that continuously threads and winds up the SUS301 strip, the first step of electrolytic-degreasing, pickling and electrolytic-activating the SUS301 strip, the second step of implementing the nickel plating (or nickel-cobalt plating) and washing, the third step of implementing the copper plating and washing and the fourth step of the silver strike plating, silver plating, washing and drying are respectively carried out.

The followings are the processing conditions of the respective steps.

1. First Step (Electrolytic Degreasing, Electrolytic Activation):

The same with the manufacturing method of the first mode.

2. Second Step:

### (1) In Case of Nickel Plating:

Plating is implemented by electrolyzing with an electrolytic solution containing 10 to 50 g of nickel chloride hexahydrate (25 g/liter in the present embodiment) and 30 to 100 g of free hydrochloric acid (50 g/liter in the present embodiment) with 2 to 5 A/dm² of cathode current density (3 A/dm² in the present embodiment). The cathode current density and the flow of the plating solution are appropriately changed so that the underlying missing portions 121 are formed in the underlying region 120.

### (2) In Case of Nickel Alloy Plating:

Plating is implemented by adding cobalt chloride hexahydrate or secondary copper chloride dehydrate into the plating solution described above so that cobalt ion concentration or copper ion concentration within the plating solution corresponds to 5 to 20% of concentration (10% in the present embodiment) in which nickel ion and cobalt ion or copper ion are added.

3. Third Step:

The same with the manufacturing method of the first mode.

4. Fourth Step:

The same with the manufacturing method of the first mode.

Table 7 shows samples of the present embodiment in which thicknesses of the underlying region 120, the intermediate layer 130 and the outermost layer 140 are changed variously. Here, a rate (area ratio) of the underlying region 120 covered on the surface of the base material 110 is represented as a coverage and the current density of the electric current flowing through the base material 110 is controlled so that the coverage turns out to be 80%. It is noted that heat treatment of two hours at 250° C. within argon (Ar) gas atmosphere was carried out on the sample Nos. 49B through 52B of the embodiment shown in Table 7.

A switch 200 having the structure shown in FIGS. 3 and 4 was made by using the silver-coated composite material for movable contacts in Table 7 manufactured under the processing conditions described above. The structure of the switch and the evaluation method of the silver-coated composite material for movable contact are the same with the first mode of the silver-coated composite material for movable contact described above.

The keying test was carried out by repeating the On/Off states shown in FIGS. 4A and 4B by using the switch 200 constructed as described above under the same conditions with the conditions described in the first mode of the silver-coated composite material for movable contact described above. Table 8 shows measured results of temporal changes of contact resistance during the keying test of the domed movable contact 210, representing initial values, after keying by 1 million times (After Keying 1) and after keying by 2 million times (After Keying 2), respectively. It was also observed whether or not the domed movable contact 210 generated cracks after finishing the keying test of 2 million times and Table 8 also shows its results. It is noted that the value of the contact resistance is considered to be practically permissible if it is less than 100 mΩ.

A heating test was carried out on all of the samples by heating for 1,000 hours in air bath at 85° C. Changes of the contact resistance were measured and Table 8 shows its results.

TABLE 7

| | | OUTERMOST | | INTERMEDIATE | | | | | INTERMEDIATE + |
|---|---|---|---|---|---|---|---|---|---|
| | | LAYER | | LAYER | | UNDER LAYER | | | UNDER |
| | SAMPLE | | AVERAGE | | MINIMUM | | MAXIMUM | COVERAGE | TOTAL AVERAGE |
| | No. | SPECIES | THICK (μm) | SPECIES | THICK (μm) | SPECIES | THICK(μm) | (%) | THICK (μm) |
| EMBODIMENT | 1B | Ag | 1.0 | Cu | 0.15 | Ni | 0.040 | 80 | 0.190 |
| | 2B | Ag | 1.0 | Cu | 0.10 | Ni | 0.040 | 80 | 0.140 |
| | 3B | Ag | 1.0 | Cu | 0.04 | Ni | 0.040 | 80 | 0.080 |
| | 4B | Ag | 1.0 | Cu | 0.02 | Ni | 0.040 | 80 | 0.060 |
| | 5B | Ag | 1.0 | Cu | 0.15 | Ni | 0.020 | 80 | 0.170 |
| | 6B | Ag | 1.0 | Cu | 0.10 | Ni | 0.020 | 80 | 0.120 |
| | 7B | Ag | 1.0 | Cu | 0.04 | Ni | 0.020 | 80 | 0.060 |
| | 8B | Ag | 1.0 | Cu | 0.02 | Ni | 0.020 | 80 | 0.040 |
| | 9B | Ag | 1.0 | Cu | 0.15 | Ni | 0.012 | 80 | 0.162 |
| | 10B | Ag | 1.0 | Cu | 0.10 | Ni | 0.012 | 80 | 0.112 |
| | 11B | Ag | 1.0 | Cu | 0.04 | Ni | 0.012 | 80 | 0.052 |
| | 12B | Ag | 1.0 | Cu | 0.02 | Ni | 0.012 | 80 | 0.032 |
| | 13B | Ag | 1.0 | Cu | 0.15 | Ni | 0.009 | 80 | 0.159 |
| | 14B | Ag | 1.0 | Cu | 0.10 | Ni | 0.009 | 80 | 0.109 |
| | 15B | Ag | 1.0 | Cu | 0.04 | Ni | 0.009 | 80 | 0.049 |
| | 16B | Ag | 1.0 | Cu | 0.02 | Ni | 0.009 | 80 | 0.029 |
| | 17B | Ag | 1.0 | Cu | 0.15 | Ni | 0.005 | 80 | 0.155 |
| | 18B | Ag | 1.0 | Cu | 0.10 | Ni | 0.005 | 80 | 0.105 |
| | 19B | Ag | 1.0 | Cu | 0.04 | Ni | 0.005 | 80 | 0.045 |
| | 20B | Ag | 1.0 | Cu | 0.02 | Ni | 0.005 | 80 | 0.025 |
| | 21B | Ag | 1.0 | Cu | 0.15 | Ni | 0.001 | 80 | 0.151 |
| | 22B | Ag | 1.0 | Cu | 0.10 | Ni | 0.001 | 80 | 0.101 |
| | 23B | Ag | 1.0 | Cu | 0.04 | Ni | 0.001 | 80 | 0.041 |
| | 24B | Ag | 1.0 | Cu | 0.03 | Ni | 0.001 | 80 | 0.031 |
| | 25B | Ag | 0.5 | Cu | 0.10 | Ni | 0.040 | 80 | 0.140 |
| | 26B | Ag | 0.5 | Cu | 0.04 | Ni | 0.040 | 80 | 0.080 |
| | 27B | Ag | 0.5 | Cu | 0.10 | Ni | 0.020 | 80 | 0.120 |
| | 28B | Ag | 0.5 | Cu | 0.04 | Ni | 0.020 | 80 | 0.060 |
| | 29B | Ag | 0.5 | Cu | 0.10 | Ni | 0.012 | 80 | 0.112 |
| | 30B | Ag | 0.5 | Cu | 0.04 | Ni | 0.012 | 80 | 0.052 |
| | 31B | Ag | 0.5 | Cu | 0.10 | Ni | 0.009 | 80 | 0.109 |
| | 32B | Ag | 0.5 | Cu | 0.04 | Ni | 0.009 | 80 | 0.049 |
| | 33B | Ag | 0.5 | Cu | 0.10 | Ni | 0.005 | 80 | 0.105 |
| | 34B | Ag | 0.5 | Cu | 0.04 | Ni | 0.005 | 80 | 0.045 |
| | 35B | Ag | 0.5 | Cu | 0.10 | Ni | 0.001 | 80 | 0.101 |
| | 36B | Ag | 0.5 | Cu | 0.04 | Ni | 0.001 | 80 | 0.041 |
| | 37B | Ag | 1.5 | Cu | 0.10 | Ni | 0.040 | 80 | 0.140 |
| | 38B | Ag | 1.5 | Cu | 0.04 | Ni | 0.040 | 80 | 0.080 |
| | 39B | Ag | 1.5 | Cu | 0.10 | Ni | 0.020 | 80 | 0.120 |
| | 40B | Ag | 1.5 | Cu | 0.04 | Ni | 0.020 | 80 | 0.060 |
| | 41B | Ag | 1.5 | Cu | 0.10 | Ni | 0.012 | 80 | 0.112 |
| | 42B | Ag | 1.5 | Cu | 0.04 | Ni | 0.012 | 80 | 0.052 |
| | 43B | Ag | 1.5 | Cu | 0.10 | Ni | 0.009 | 80 | 0.109 |
| | 44B | Ag | 1.5 | Cu | 0.04 | Ni | 0.009 | 80 | 0.049 |
| | 45B | Ag | 1.5 | Cu | 0.10 | Ni | 0.005 | 80 | 0.105 |
| | 46B | Ag | 1.5 | Cu | 0.04 | Ni | 0.005 | 80 | 0.045 |
| | 47B | Ag | 1.5 | Cu | 0.10 | Ni | 0.001 | 80 | 0.101 |
| | 48B | Ag | 1.5 | Cu | 0.04 | Ni | 0.001 | 80 | 0.041 |
| | 49B | Ag | 1.0 | Cu | 0.10 | Ni | 0.040 | 80 | 0.140 |
| | 50B | Ag | 1.0 | Cu | 0.10 | Ni | 0.009 | 80 | 0.109 |
| | 51B | Ag | 1.0 | Cu | 0.04 | Ni | 0.040 | 80 | 0.080 |
| | 52B | Ag | 1.0 | Cu | 0.04 | Ni | 0.009 | 80 | 0.049 |
| COMPARATIVE | 101B | Ag | 1.0 | Cu | 0.01 | Ni | 0.009 | 100 | 0.019 |
| EXAMPLE | 102B | Ag | 1.0 | Cu | 0.10 | Ni | 0.050 | 100 | 0.150 |
| | 103B | Ag | 1.0 | Cu | 0.30 | Ni | 0.050 | 100 | 0.350 |
| | 104B | Ag | 1.0 | Cu | 0.10 | Ni | 0.100 | 100 | 0.200 |
| | 105B | Ag | 1.0 | Cu | 0.30 | Ni | 0.100 | 100 | 0.400 |
| | 106B | Ag | 1.0 | Cu | 0.01 | Ni | 0.300 | 100 | 0.310 |
| | 107B | Ag | 1.0 | Cu | 0.10 | Ni | 0.300 | 100 | 0.400 |
| | 108B | Ag | 1.0 | Cu | 0.30 | Ni | 0.300 | 100 | 0.600 |

TABLE 8

| | | | | | | | | APPEARANCE AFTER | |
|---|---|---|---|---|---|---|---|---|---|
| | | | | CONTACT RESISTANCE (mΩ) | | | | KEYING 2 | |
| | SAMPLE | TREATED | PROC- | INITIAL | AFTER | AFTER | HEATING | UNDERLAYER | |
| | No. | BY HEAT? | ESSABILITY | VALUE | KEYING 1 | KEYING 2 | TEST | EXPOSED? | CRACK |
| EMBODIMENT | 1B | none | ◯ | 11 | 14 | 35 | 84 | none | none |
| | 2B | none | ◯ | 12 | 14 | 31 | 72 | none | none |
| | 3B | none | ◯ | 12 | 14 | 27 | 58 | none | none |
| | 4B | none | ◯ | 12 | 14 | 25 | 52 | none | none |
| | 5B | none | ◯ | 10 | 14 | 33 | 87 | none | none |
| | 6B | none | ◯ | 10 | 13 | 29 | 73 | none | none |
| | 7B | none | ◯ | 10 | 13 | 25 | 60 | none | none |
| | 8B | none | ◯ | 11 | 14 | 24 | 54 | none | none |
| | 9B | none | ◯ | 10 | 14 | 31 | 90 | none | none |
| | 10B | none | ◯ | 10 | 13 | 28 | 77 | none | none |
| | 11B | none | ◯ | 11 | 14 | 24 | 63 | none | none |
| | 12B | none | ◯ | 11 | 14 | 23 | 55 | none | none |
| | 13B | none | ⊚ | 10 | 13 | 29 | 91 | none | none |
| | 14B | none | ⊚ | 10 | 13 | 26 | 76 | none | none |
| | 15B | none | ⊚ | 11 | 13 | 22 | 61 | none | none |
| | 16B | none | ⊚ | 11 | 14 | 22 | 55 | none | none |
| | 17B | none | ⊚ | 10 | 13 | 29 | 91 | none | none |
| | 18B | none | ⊚ | 10 | 13 | 26 | 76 | none | none |
| | 19B | none | ⊚ | 10 | 13 | 21 | 60 | none | none |
| | 20B | none | ⊚ | 10 | 13 | 21 | 54 | none | none |
| | 21B | none | ⊚ | 9 | 13 | 30 | 92 | none | none |
| | 22B | none | ⊚ | 10 | 13 | 26 | 76 | none | none |
| | 23B | none | ⊚ | 10 | 13 | 22 | 61 | none | none |
| | 24B | none | ⊚ | 10 | 13 | 22 | 55 | none | none |
| | 25B | none | ◯ | 13 | 17 | 39 | 74 | none | none |
| | 26B | none | ◯ | 13 | 17 | 36 | 61 | none | none |
| | 27B | none | ◯ | 13 | 16 | 39 | 75 | none | none |
| | 28B | none | ◯ | 13 | 16 | 35 | 63 | none | none |
| | 29B | none | ◯ | 12 | 16 | 37 | 76 | none | none |
| | 30B | none | ◯ | 12 | 16 | 34 | 64 | none | none |
| | 31B | none | ⊚ | 12 | 16 | 35 | 77 | none | none |
| | 32B | none | ⊚ | 12 | 16 | 32 | 64 | none | none |
| | 33B | none | ⊚ | 12 | 15 | 34 | 76 | none | none |
| | 34B | none | ⊚ | 12 | 15 | 32 | 63 | none | none |
| | 35B | none | ⊚ | 12 | 15 | 34 | 77 | none | none |
| | 36B | none | ⊚ | 12 | 15 | 32 | 64 | none | none |
| | 37B | none | ◯ | 10 | 13 | 32 | 69 | none | none |
| | 38B | none | ◯ | 10 | 13 | 30 | 59 | none | none |
| | 39B | none | ◯ | 10 | 13 | 32 | 69 | none | none |
| | 40B | none | ◯ | 10 | 13 | 29 | 58 | none | none |
| | 41B | none | ◯ | 10 | 13 | 31 | 68 | none | none |
| | 42B | none | ◯ | 10 | 13 | 29 | 56 | none | none |
| | 43B | none | ⊚ | 10 | 13 | 19 | 70 | none | none |
| | 44B | none | ⊚ | 10 | 13 | 18 | 61 | none | none |
| | 45B | none | ⊚ | 9 | 12 | 19 | 69 | none | none |
| | 46B | none | ⊚ | 9 | 12 | 18 | 60 | none | none |
| | 47B | none | ⊚ | 9 | 12 | 19 | 70 | none | none |
| | 48B | none | ⊚ | 9 | 12 | 19 | 61 | none | none |
| | 49B | yes | ◯ | 14 | 16 | 28 | 47 | none | none |
| | 50B | yes | ⊚ | 14 | 16 | 27 | 46 | none | none |
| | 51B | yes | ◯ | 13 | 15 | 25 | 35 | none | none |
| | 52B | yes | ⊚ | 13 | 15 | 24 | 34 | none | none |
| COMPARATIVE | 101B | none | X | 15 | 50 | 560 | 60 | none | yes |
| EXAMPLE | 102B | none | Δ | 12 | 18 | 125 | 75 | none | yes |
| | 103B | none | Δ | 13 | 35 | 330 | 820 | none | yes |
| | 104B | none | X | 14 | 20 | 145 | 72 | none | yes |
| | 105B | none | X | 15 | 44 | 420 | 760 | yes | yes |
| | 106B | none | X | 16 | 36 | 510 | 125 | yes | yes |
| | 107B | none | X | 16 | 30 | 170 | 162 | yes | yes |
| | 108B | none | X | 17 | 61 | 750 | 1250 | yes | yes |

The increase of the contact resistance of all of the sample Nos. 1B through 52B of the embodiment shown in Table 7 was small even after the keying test of 2 million times and no exposure of the underlying region 120 and the intermediate layer 130 was seen in the contact point after keying 2 million times as shown in Table 8. Still more, the increase of the contact resistance was small even after heating for 1,000 hours and the value of the contact resistance of the all samples was less than 100 mΩ, which is practically no problem.

However, the sample No. 101B of a comparative example in which a total thickness of the underlying region 120 and the intermediate layer 130 is less than 0.025 μm deteriorates its workability due to the drop of the adhesion of the respective layers and the sample Nos. 102B through 108B in which the thickness of the underlying region 120 exceeds the upper limit of the range of the invention (0.05 μm or more) have a tendency to deteriorate their workability. Still more, an increase of the contact resistance considered to be caused by deteriorated workability (specifically, the state in which the value of the contact resistance exceeds 100 mΩ) is detected in the sample Nos. 101B through 108B of the comparative examples after keying by 2 million times.

Still more, a crack was found in the contact part of the sample Nos. 101B through 108B of the comparative example and the outermost layer of the contact part peeled and the under layer was exposed in the sample Nos. 106B through 108B whose underlying region 120 is 0.3 μm thick.

Meanwhile, the contact resistance remarkably increased (to the state in which the value of the contact resistance exceeds 100 mΩ in concrete) after the heating test and cracks and exposure of the under layer were seen after the keying test in the sample Nos. 103B, 105B and 108B whose intermediate layer 120 is 0.3 μm thick.

(Second Embodiment of Manufacturing Method of Fifth Mode)

Here, a second embodiment of the manufacturing method of the fifth mode for manufacturing the silver-coated composite material for movable contact 100B will be explained. About the underlying region 120: When nickel alloy plating in which 10 mass % of nickel is replaced with copper or cobalt was used and tested in the same manner with the sample Nos. 1B through 52B and sample Nos. 101B through 108B in Table 7, the test result was substantially the same with the results shown in Table 8. The same also applies to a case when nickel is completely replaced with cobalt.

About the intermediate layer 130: When copper alloy plating in which 0.5 mass % of copper is replaced with tin or zinc was used and tested in the same manner with the sample Nos. 1B through 52B and sample Nos. 101B through 108B in Table 7, the test result was substantially the same with the results shown in Table 8.

About the outermost layer 140: When silver alloy plating in which 1 mass % of silver is replaced with antimony was used and tested in the same manner with the sample Nos. 1B through 52B and sample Nos. 101B through 108B in Table 7, the test result was substantially the same with the results shown in Table 8.

Still more, when the modified samples described above were appropriately combined, the test results were substantially the same with the results shown in Table 8.

(Sixth Mode of Manufacturing Method of Silver-Coated Composite Material for Movable Contact)

Next, a sixth mode of the manufacturing method for manufacturing the silver-coated composite material for movable contact 100B shown in FIG. 9 will be explained.

The manufacturing method of the silver-coated composite material for movable contact of the sixth mode has the following steps.

(First Step) The base material (base material of the metal strip) 110 which is a stainless strip composed of an alloy whose main component is iron or nickel is electrolytic-degreased and then activated by pickling by an acid solution containing nickel ion to form the underlying region 120 which is composed of nickel and which has the underlying missing portions 121 at a plurality of spots on the base material 110.

The activation process for activating the base material 110 is carried out under the following conditions for example in this first step.

(1) As the acid solution containing nickel ion, an acid solution to which 120 g/liter of free hydrochloric acid and 12 g/liter of nickel chloride hexahydrate are added is used. It is noted that as the acid solution containing nickel ion, it is preferable to add free hydrochloric acid in a range of 80 to 200 g/liter (or more preferably 100 to 150 g/liter) and nickel chloride hexahydrate in a range of 5 to 20 g/liter (or more preferably 10 to 15 g/liter). When the additive amounts of free hydrochloric acid and nickel chloride hexahydrate are out of those ranges, the adhesion between the base material and the underlying region tends to drop in all of the cases.

(2) The cathode current density during the activation process is set at 2.5 (A/dm²). It is noted that the cathode current density during the activation process is preferable to be in a range of 2.0 to 5.0 (A/dm²) and is more preferable to be in a range of 2.0 to 3.5 (A/dm²) from the aspect of effectively forming the missing portions in the underlying region. When the cathode current density during the activation process is less than 2.0 (A/dm²), it is not preferable because the adhesion between the base material and the under layer tends to drop. Still more, when the cathode current density during the activation process is higher than 5.0 (A/dm²), it is also not so preferable because there is a case when an influence of generated heat of the base material is brought out when the base material is stainless steel.

By carrying out the activation process of the base material 110 shown in FIG. 10A under such conditions, nucleuses 120c of nickel (Ni) that become the underlying region 120 are formed with intervals larger than that of the nucleuses 120b of nickel (Ni) shown in FIG. 8B on the whole surface of the base material 110 (see FIG. 10B) and the underlying region 120 having the underlying missing portions 121 on the whole surface of the base material 110 (see FIG. 10C).

(Second Step) The intermediate layer 130 is formed on the underlying region 120 by plating copper by electrolyzing with an electrolytic solution containing copper sulfate and free sulfuric acid with 5 A/dm² of cathode current density.

(Third Step) The outermost layer 140 is formed on the intermediate layer 130 by plating silver by electrolyzing with an electrolytic solution containing silver cyanide and potassium cyanide.

Thus, the underlying region 120 having the underlying missing portions 121 is formed on the whole surface of the base material 110 during the activation process of the base material 110 in the manufacturing method of the silver-coated composite material for movable contact of the present mode. Therefore, it becomes unnecessary to carry out the step of nickel plating or nickel alloy plating for forming the underlying region 120 (S2 in FIG. 2) in the manufacturing method of the silver-coated composite material for movable contact of the first mode described above by using FIG. 2. Accordingly, the manufacturing step is simplified and operation time may be shortened, so that the silver-coated composite material for movable contact may be manufactured at low cost.

Still more, while part of the surface of the base material 110 composed of the alloy whose main component is iron or nickel or of stainless steel is exposed at the spots of 121, the adhesion with the intermediate layer 130 does not drop because the base material 110 is electrolytic-degreased in the first step and is pickled and activated by the acid solution containing nickel ion.

Further, the underlying region 120 having the underlying missing portions 121 at the plurality of spots may be faulted on the base material 110 during the activation process of the base material 110 composed of stainless steel. The adhesion of the base material 110 with the under layer 120 may be improved by thus forming the underlying region 120.

Still more, the underlying missing portions (missing portions) 121 are formed at the plurality of spots of the underlying region 120 so that the intermediate layer 130 contacts directly with the base material 110 through the underlying a missing portions 121, so that the adhesion between the underlying region 120 and the intermediate layer 130 may be improved and the longer-life silver-coated composite material for movable contact may be obtained.

As samples manufactured by the manufacturing method of the sixth mode described above, samples in which thicknesses of the underlying region 120, the intermediate layer 130 and the outermost layer 140 are changed variously in the same manner with the samples of the embodiment respectively shown in Table 7 were prepared and represented as sample Nos. 201B through 252B (see Table 9). It is noted that heat treatment of two hours at 250° C. within argon (Ar) gas atmosphere was carried out on the sample Nos. 249B through 252B of the embodiment shown in Table 9. Still more, sample Nos. 301B through 308B (see Table 9) were prepared as comparative examples. It is noted that the sample Nos. 201B through 252B in Table 9 are samples respectively having the same layer structure with the sample Nos. 1B through 52B in Table 7 and the sample Nos. 301B through 308B of the comparative examples shown in Table 7 are samples respectively having the same layer structure with those of the sample Nos. 101B through 108B of the comparative examples shown in Table 7. Their correspondence relationship is made such that the sample No. of the embodiment shown in Table 7 added with 200 is the sample No. of the embodiment shown in Table 9.

A switch similar to the switch 200 having the structure as shown in FIGS. 3 and 4 was made by using the silver-coated composite material for movable contacts of the sample Nos. 201B through 252B manufactured under the processing conditions described above and the sample Nos. 301B through 308B. The other conditions were the same with those of the case when the silver-coated composite material for movable contacts of the sample Nos. 1B through 52B and the sample Nos. 101B through 108B described above were used.

The keying test was carried out by repeating the On/Off states as shown in FIGS. 4A and 4B by using the switch constructed as described above. During the keying test, keying of 2 million times in maximum is carried out with 9.8 N/mm² of contact pressure and 5 Hz of keying speed. Table 9 shows measured results of temporal changes of contact resistance during the keying test of the domed movable contact 210, representing initial values, after keying by 1 million times (After Keying 1) and after keying by 2 million times (After Keying 2), respectively. It was also observed whether or not the domed movable contact 210 generated cracks after finishing the keying test of 2 million times and Table 9 also shows its results.

A heating test was carried out on all of the samples by heating for 1,000 hours in air bath at 85° C. Changes of the contact resistance were measured and Table 9 shows its result.

TABLE 9

| | | | | | | | | APPEARANCE AFTER | |
|---|---|---|---|---|---|---|---|---|---|
| | | | | CONTACT RESISTANCE (mΩ) | | | | KEYING 2 | |
| | SAMPLE | HEAT | PROC- | INITIAL | AFTER | AFTER | HEATING | UNDERLAYER | |
| | No. | TREATMENT | ESSABILITY | VALUE | KEYING 1 | KEYING 2 | TEST | EXPOSED? | CRACK |
| EMBODIMENT | 201B | none | ◯ | 11 | 12 | 16 | 17 | none | none |
| | 202B | none | ◯ | 12 | 12 | 16 | 15 | none | none |
| | 203B | none | ◯ | 12 | 12 | 16 | 15 | none | none |
| | 204B | none | ◯ | 12 | 12 | 15 | 15 | none | none |
| | 205B | none | ◯ | 10 | 11 | 16 | 14 | none | none |
| | 206B | none | ◯ | 10 | 11 | 16 | 14 | none | none |
| | 207B | none | ◯ | 10 | 11 | 15 | 14 | none | none |
| | 206B | none | ◯ | 11 | 11 | 15 | 15 | none | none |
| | 209B | none | ◯ | 10 | 11 | 16 | 15 | none | none |
| | 210B | none | ◯ | 10 | 11 | 16 | 14 | none | none |
| | 211B | none | ◯ | 11 | 11 | 16 | 14 | none | none |
| | 212B | none | ◯ | 11 | 12 | 16 | 15 | none | none |
| | 213B | none | ⊚ | 10 | 11 | 16 | 14 | none | none |
| | 214B | none | ⊚ | 10 | 11 | 15 | 14 | none | none |
| | 215B | none | ⊚ | 11 | 12 | 16 | 15 | none | none |
| | 216B | none | ⊚ | 11 | 12 | 15 | 15 | none | none |
| | 217B | none | ⊚ | 10 | 11 | 15 | 15 | none | none |
| | 218B | none | ⊚ | 10 | 11 | 15 | 15 | none | none |
| | 219B | none | ⊚ | 10 | 11 | 15 | 14 | none | none |
| | 220B | none | ⊚ | 10 | 11 | 15 | 14 | none | none |
| | 221B | none | ⊚ | 9 | 10 | 14 | 13 | none | none |
| | 222B | none | ⊚ | 10 | 10 | 14 | 14 | none | none |
| | 223B | none | ⊚ | 10 | 11 | 14 | 14 | none | none |
| | 224B | none | ⊚ | 10 | 11 | 14 | 14 | none | none |
| | 225B | none | ◯ | 13 | 15 | 20 | 24 | none | none |
| | 226B | none | ◯ | 13 | 15 | 20 | 23 | none | none |
| | 227B | none | ◯ | 13 | 15 | 20 | 25 | none | none |
| | 228B | none | ◯ | 13 | 15 | 20 | 23 | none | none |
| | 229B | none | ◯ | 12 | 14 | 20 | 24 | none | none |
| | 230B | none | ◯ | 12 | 14 | 19 | 22 | none | none |
| | 231B | none | ⊚ | 12 | 14 | 20 | 23 | none | none |
| | 232B | none | ⊚ | 12 | 14 | 19 | 22 | none | none |
| | 233B | none | ⊚ | 12 | 14 | 20 | 23 | none | none |
| | 234B | none | ⊚ | 12 | 14 | 19 | 21 | none | none |
| | 235B | none | ⊚ | 12 | 14 | 20 | 23 | none | none |
| | 236B | none | ⊚ | 12 | 14 | 19 | 21 | none | none |
| | 237B | none | ◯ | 10 | 11 | 13 | 13 | none | none |
| | 236B | none | ◯ | 10 | 11 | 13 | 13 | none | none |
| | 239B | none | ◯ | 10 | 11 | 12 | 13 | none | none |
| | 240B | none | ◯ | 10 | 11 | 12 | 13 | none | none |
| | 241B | none | ◯ | 9 | 10 | 12 | 12 | none | none |
| | 242B | none | ◯ | 9 | 10 | 11 | 13 | none | none |
| | 243B | none | ⊚ | 10 | 10 | 11 | 12 | none | none |
| | 244B | none | ⊚ | 10 | 10 | 11 | 13 | none | none |
| | 245B | none | ⊚ | 9 | 10 | 11 | 12 | none | none |
| | 246B | none | ⊚ | 9 | 10 | 11 | 13 | none | none |
| | 247B | none | ⊚ | 9 | 9 | 10 | 12 | none | none |
| | 248B | none | ⊚ | 9 | 9 | 10 | 12 | none | none |
| | 249B | yes | ◯ | 14 | 15 | 18 | 17 | none | none |
| | 250B | yes | ⊚ | 14 | 14 | 17 | 17 | none | none |
| | 251B | yes | ◯ | 13 | 14 | 16 | 16 | none | none |
| | 252B | yes | ⊚ | 13 | 14 | 16 | 16 | none | none |
| COMPARATIVE | 301B | none | X | 15 | 50 | 410 | 63 | none | yes |
| EXAMPLE | 302B | none | Δ | 12 | 18 | 115 | 67 | none | yes |
| | 303B | none | Δ | 13 | 35 | 290 | 670 | none | yes |
| | 304B | none | X | 14 | 20 | 135 | 68 | none | yes |
| | 305B | none | X | 15 | 44 | 370 | 630 | yes | yes |
| | 306B | none | X | 16 | 36 | 450 | 105 | yes | yes |
| | 307B | none | X | 16 | 30 | 140 | 139 | yes | yes |
| | 308B | none | X | 17 | 61 | 630 | 1040 | yes | yes |

The increase of the contact resistance of all of the sample Nos. 201B through 252B of the embodiment shown in Table 9 was small even after the keying test of 2 million times and no exposure of the underlying region 120 and the intermediate layer 130 was seen in the contact point after keying 2 million times. Still more, the increase of the contact resistance was small even after heating for 1,000 hours. Specifically, it was found that the increase of the contact resistance after the keying test of 2 million times and the increase of the contact resistance after heating for 1,000 hours of the sample Nos. 201B through 252B shown in Table 9 were small as compared to those of the sample Nos. 1B through 52B of the embodiment shown in Table 7, that the value of the contact resistance of all of the samples is less than 30 mΩ and that the performance as a material of the contact is very excellent. It is noted that each embodiment explained in the first and second embodiments of the manufacturing method of the fifth mode is applicable to the manufacturing method of the sixth mode described above.

As described above, the invention provides the silver-coated composite material for movable contact, and its manufacturing method, whose outermost layer (silver-coated layer) is not peeled off even in the repeated switching operation of the contact and which is capable of suppressing the increase of the contact resistance even used for a long period of time. Accordingly, the long-life movable contact may be manufactured by using the silver-coated composite material for movable contact of the invention and its industrial applicability is large.

1. A silver-coated composite material for movable contact, comprising:
a base material composed of an alloy whose main component is iron or nickel;
an under layer which is formed at least on part of the surface of said base material and which is composed of any one of nickel, cobalt, nickel alloy and cobalt alloy;
an intermediate layer which is formed on said under layer and which is composed of copper or copper alloy; and
an outermost layer which is formed on said intermediate layer and which is composed of silver or silver alloy: and
wherein a total thickness of said under layer and said intermediate layer falls within a range more than 0.025 μm and less than 0.20 μm.

2. The silver-coated composite material for movable contact according to claim 1, wherein the thickness of said under layer is 0.04 μm or less.

3. The silver-coated composite material for movable contact according to claim 1, wherein the thickness of said under layer is 0.009 μm or less.

4. The silver-coated composite material for movable contact according to claim 1, wherein said base material is stainless steel.

5. The silver-coated composite material for movable contact according to claim 1, wherein irregularity is formed at the interface between said under layer and said intermediate layer.

6. The silver-coated composite material for movable contact according to claim 5, wherein irregularity is formed at the interface between said intermediate layer and said outermost layer.

7. The silver-coated composite material for movable contact according to claim 1, wherein missing portions are formed at a plurality of spots of said under layer so that said intermediate layer directly contacts with the surface of said base material.

8. A method for manufacturing a silver-coated composite material for movable contact, comprising:
a first step of electrolytic-degreasing a base material of a metal strip composed of an alloy whose main component is iron or nickel and of pickling and activating the base material by hydrochloric acid;
a second step of forming an under layer by implementing either nickel plating by electrolyzing with an electrolytic solution containing nickel chloride and free hydrochloric acid or plating nickel alloy plating by electrolyzing by adding cobalt chloride to the electrolytic solution containing nickel chloride and free hydrochloric acid;
a third step of forming an intermediate layer by implementing either copper plating by electrolyzing with an electrolytic solution containing copper sulfate and free sulfuric acid or copper alloy plating by electrolyzing by adding zinc cyanide or potassium stannate based on copper cyanide and potassium cyanide; and
a fourth step of forming an outermost layer by implementing either silver plating by electrolyzing with an electrolytic solution containing silver cyanide and potassium cyanide or silver alloy plating by electrolyzing by adding antimonyl potassium tartrate to the electrolytic solution containing silver cyanide and potassium cyanide: and
wherein the silver-coated composite material for movable contact is manufactured so that a total thickness of said under layer and said intermediate layer thereof falls within a range more than 0.025 μam and less than 0.20 μam.

9. The silver-coated composite material for movable contact according to claim 8, wherein a silver-coated composite material is formed by implementing silver strike plating by electrolyzing with an electrolytic solution containing silver cyanide and potassium cyanide after implementing either the copper plating or the copper alloy plating and before implementing either the silver plating or the silver alloy plating.

10. A manufacturing method of a silver-coated composite material for movable contact comprising a base material composed of an alloy whose main component is iron or nickel, an under layer which is formed at least on part of the surface of said base material and which is composed of any one of nickel, cobalt, nickel alloy and cobalt alloy, an intermediate layer which is formed on said under layer and which is composed of copper or copper alloy and an outermost layer which is formed on said intermediate layer and which is composed of silver or silver alloy, wherein a total thickness of said under layer and said intermediate layer falls within a range more than 0.025 μam and less than 0.20 μam; and
wherein said under layer is formed by pickling and activating said base material by an acid solution at least containing nickel ion or cobalt ion after electrolytic-degreasing said base material.

11. A manufacturing method of a silver-coated composite material for movable contact, comprising:
a first step of electrolytic-degreasing a base material of a metal strip composed of an alloy whose main component is iron or nickel and then forming an under layer composed any one of nickel, cobalt, nickel alloy and cobalt alloy on said base material through an activation process of pickling and activating the base material by an acid solution containing at least nickel ion or cobalt ion;
a second step of forming an intermediate layer by plating either copper by electrolyzing with an electrolytic solution containing copper sulfate and free sulfuric acid or copper alloy by adding zinc cyanide or potassium stannate to the electrolytic solution containing copper cyanide and potassium cyanide; and
a third step of forming an outermost layer on said intermediate layer by implementing silver plating with an electrolytic solution containing silver cyanide and potassium cyanide or silver alloy plating by electrolyzing by adding antimonyl potassium tartrate to the electrolytic solution containing silver cyanide and potassium cyanide; and
wherein the silver-coated composite material for movable contact is manufactured so that a total thickness of said under layer and said intermediate layer thereof falls within a range more than 0.025 μm and less than 0.20 μm.

12. The method for manufacturing the silver-coated composite material for movable contact according to claim 10 or 11, wherein cathode current density during said activation process is set within a range from 2 to 5 (A/dm²).

13. The method for manufacturing the silver-coated composite material for movable contact according to claim 12, wherein the cathode current density during said activation process is set within a range from 3.0 to 5.0 (A/dm²) and the silver-coated composite material for movable contact is manufactured so that the thickness of said under layer is 0.04 μm or less.

14. The method for manufacturing the silver-coated composite material for movable contact according to claim 12, wherein the cathode current density during said activation process is set within a range from 2.5 to 4.0 (A/dm²) and the silver-coated composite material for movable contact is manufactured so that irregularity is formed at the interface between said under layer and said intermediate layer.

15. The method for manufacturing the silver-coated composite material for movable contact according to claim 12, wherein the cathode current density during said activation process is set within a range from 2.0 to 3.5 (A/dm²) and the silver-coated composite material for movable contact is manufactured so that missing portions are formed at a plurality of spots of said under layer so that said intermediate layer contacts directly with the surface of said base material.

16. The method for manufacturing the silver-coated composite material for movable contact according to claim 10 or 11, wherein said base material is a metal strip.

17. The method for manufacturing the silver-coated composite material for movable contact according to claim 16, wherein said base material is composed of stainless steel.
